(19) United States
(12) Patent Application Publication
(10) Pub. No.: US 2025/0260097 A1
(43) Pub. Date: Aug. 14, 2025

(54) OUTER PACKAGE MATERIAL FOR POWER STORAGE DEVICES, METHOD FOR PRODUCING IT, APPEARANCE INSPECTION METHOD, AND POWER STORAGE DEVICE

(71) Applicant: DAI NIPPON PRINTING CO., LTD., Tokyo (JP)

(72) Inventors: Shinichiro NAKAMURA, Tokyo (JP); Momoka KAWAI, Tokyo (JP); Masahiro TATSUZAWA, Tokyo (JP); Ikuma SHIOTA, Tokyo (JP); Chiaki HATSUTA, Tokyo (JP); Takanori YAMASHITA, Tokyo (JP)

(73) Assignee: DAI NIPPON PRINTING CO., LTD., Tokyo (JP)

(21) Appl. No.: 18/845,978

(22) PCT Filed: Mar. 10, 2023
(86) PCT No.: PCT/JP2023/009420

§ 371 Date: Nov. 25, 2024

(30) Foreign Application Priority Data
Mar. 11, 2022 (JP) 2022-038590

(51) Int. Cl. H01M 50/126; H01M 50/119; H01M 50/121

(52) U.S. Cl. CPC H01M 50/126; H01M 50/119; H01M 50/121

(57) ABSTRACT

An outer package material for power storage devices, the outer package material being configured from a multilayer body that comprises at least a surface coating layer, a base material layer, a barrier layer and a thermally fusible resin layer sequentially from the outer side, wherein the surface coating layer contains a resin and a filler. With respect to the outer surface of the surface coating layer, if the reflectance thereof is measured using a goniophotometer at the incident light angle of 60° for every 0.1° of the light reception angle, the ratio (A/B) of the maximum reflectance A in the light reception angle range from 55.0° to 65.0° to the maximum reflectance B in the light reception angle range from 70.0° to 80.0° is 3.50 or less.

### TECHNICAL FIELD

The present disclosure relates to an exterior material for electrical storage devices, a method for manufacturing the exterior material for electrical storage devices, an appearance inspection method, and an electrical storage device.

### BACKGROUND ART

Various types of electrical storage devices have been developed heretofore, and in every electrical storage device, an exterior material is an essential member for sealing electrical storage device elements such as an electrode and an electrolyte. Metallic exterior materials have been often used heretofore as exterior materials for electrical storage devices.

On the other hand, in recent years, electrical storage devices have been required to be diversified in shape and to be thinned and lightened with improvement of performance of electric cars, hybrid electric cars, personal computers, cameras, mobile phones and so on. However, metallic exterior material for electrical storage devices that have often been heretofore used have the disadvantage that it is difficult to keep up with diversification in shape, and there is a limit on weight reduction.

Thus, heretofore a film-shaped laminate with a base material layer, a barrier layer, an adhesive layer and a heat-sealable resin layer laminated in this order has been proposed as an exterior material for electrical storage devices which is easily processed into diversified shapes and is capable of achieving thickness reduction and weight reduction (see, for example, Patent Literature 1).

In such an exterior material for electrical storage devices, generally, a concave portion is formed by cold molding, electrical storage device elements such as an electrode and an electrolytic solution are disposed in a space formed by the concave portion, and heat-sealable resin layers are heat-sealed to obtain an electrical storage device with electrical storage device elements housed in the exterior material for electrical storage devices.

### CITATION LIST

### Patent Literature

PTL 1: Japanese Patent Laid-open Publication No. 2008-287971

### SUMMARY OF INVENTION

### Technical Problem

In a product to which an electrical storage device is applied, a high design property may be required for the electrical storage device used, for example, inside the product, as well as for the appearance of the product.

As a technique for imparting a high design property to the appearance of an electrical storage device, for example, a technique may be utilized in which a surface of an exterior material for the electrical storage device is matted. Examples of the method for imparting a matte-toned design to a surface of an exterior material for electrical storage devices include a method in which a filler is blended in an outermost layer (for example, a surface coating layer) of the exterior material for electrical storage devices. However, a matte-toned exterior material for electrical storage devices in which a filler is blended in an outermost layer has a problem that viewing from the front and viewing at a tilt give different color tones, and thus, it is difficult to obtain a uniform appearance.

In recent years, with the rapid spread of products with electrical storage devices, electrical storage devices used inside the product are required to have a higher appearance design property.

Under these circumstances, a main object of the present disclosure is to provide an exterior material for electrical storage devices which includes a laminate including at least a surface coating layer, a base material layer, a barrier layer, and a heat-sealable resin layer in this order from the outside and which has an excellent matte-toned appearance even in observation of the outer surface from various angles.

### Solution to Problem

The inventors of the present disclosure have extensively conducted studies for solving the above-described problems. As a result, the inventors have devised an exterior material for electrical storage devices which includes a laminate including at least a surface coating layer, a base material layer, a barrier layer, and a heat-sealable resin layer in this order from an outside, in which the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less. The exterior material for electrical storage devices has an excellent matte-toned appearance even in observation of the outer surface from various angles.

The present disclosure has been completed by further conducting studies on the basis the above-mentioned findings. That is, the present disclosure provides an invention of an aspect as described below.

An exterior material for electrical storage devices which includes a laminate including at least a surface coating layer, a base material layer, a barrier layer, and a heat-sealable resin layer in this order from an outside, in which the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less.

### Advantageous Effects of Invention

According to the present disclosure, it is possible to provide an exterior material for electrical storage devices which includes a laminate including at least a surface coating layer, a base material layer, a barrier layer, and a heat-sealable resin layer in this order from the outside and which has an excellent matte-toned appearance even in observation of the outer surface from various angles. According to the present disclosure, it is also possible to provide a method for manufacturing an exterior material for electrical storage devices, an appearance inspection method, and an electrical storage device. The exterior material for electrical storage devices according to the present disclosure, which has an excellent matte-toned appearance even in observation from various angles, thus also has the advantage of being excellent in terms of quality control with errors being unlikely to occur in an inspection step.

### BRIEF DESCRIPTION OF DRAWINGS

FIG. 1 is a schematic diagram showing an example of a cross-sectional structure of an exterior material for electrical storage devices according to the present disclosure.

FIG. 2 is a schematic diagram showing an example of a cross-sectional structure of an exterior material for electrical storage devices according to the present disclosure.

FIG. 3 is a schematic diagram showing an example of a cross-sectional structure of an exterior material for electrical storage devices according to the present disclosure.

FIG. 4 is a schematic diagram for illustrating a method for housing an electrical storage device element in a packaging formed from an exterior material for electrical storage devices according to the present disclosure.

FIG. 5 is a schematic diagram of a graph obtained using a goniophotometer (the horizontal axis represents the light reception angle) (°, and the vertical axis represents the reflectance (%)).

### DESCRIPTION OF EMBODIMENTS

The exterior material for electrical storage devices according to the present disclosure is an exterior material for electrical storage devices which includes a laminate including at least a surface coating layer, a base material layer, a barrier layer, and a heat-sealable resin layer in this order from an outside, in which the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less. The exterior material for electrical storage devices according to the present disclosure, which has such a configuration, thus has an excellent matte-toned appearance even in observation of the outer surface from various angles.

Hereinafter, the exterior material for electrical storage devices according to the present disclosure will be described in detail. In the present disclosure, a numerical range indicated by the term “A to B” means “A or more” and “B or less”. For example, the expression of “2 to 15 mm” means 2 mm or more and 15 mm or less. In numerical ranges serially described in the present disclosure, an upper limit value or a lower limit value described for a numerical range may be replaced by an upper limit value or a lower limit value of one of other serially described numerical ranges. Upper limit values, upper and lower limit values, or lower limit values, which are described for different ranges, may be combined to form a numerical range. In numerical ranges described in the present disclosure, an upper limit value or a lower limit value described for a numerical range may be replaced by a value shown in an example.

In the exterior material for electrical storage devices, Machine Direction (MD) and Transverse Direction (TD) in the process for manufacturing thereof can be discriminated from each other for the barrier layer 3 described later. For example, when the barrier layer 3 includes a metal foil such as an aluminum alloy foil or a stainless steel foil, linear streaks called rolling indentations are formed on the surface of the metal foil in the rolling direction (RD) of the metal foil. Since the rolling indentations extend along the rolling direction, the rolling direction of the metal foil can be known by observing the surface of the metal foil. In the process for manufacturing of the laminate, the MD of the laminate and the RD of the metal foil normally coincides with each other, and therefore by observing the surface of the metal foil of the laminate to identify the rolling direction (RD) of the metal foil, the MD of the laminate can be identified. Since the TD of the laminate is perpendicular to the MD of the laminate, the TD of the laminate can be identified.

If the MD of the exterior material for electrical storage devices cannot be identified by the rolling indentations of the metal foil such as an aluminum alloy foil or a stainless steel foil, the MD can be identified by the following method. Examples of the method for identifying the MD of the exterior material for electrical storage devices include a method in which a cross-section of the heat-sealable resin layer of the exterior material for electrical storage devices is observed with an electron microscope to examine a sea-island structure. In the method, the direction parallel to a cross-section in which the average of the diameters of the island shapes in a direction perpendicular to the thickness direction of the heat-sealable resin layer is maximum can be determined as MD. Specifically, a cross-section in the length direction of the heat-sealable resin layer and cross-sections (a total of 10 cross-sections) at angular intervals of 10 degrees from a direction parallel to the cross-section in the length direction to a direction perpendicular to the cross-section in the length direction are observed with an electron microscope photograph to examine sea-island structures. Next, in each cross-section, the shape of each island is observed. For the shape of each island, the linear distance between the leftmost end in a direction perpendicular to the thickness direction of the heat-sealable resin layer and the rightmost end in the perpendicular direction is taken as a diameter y. In each cross-section, the average of the top 20 diameters y in descending order of the diameter y of the island shape is calculated. The direction parallel to a cross-section having the largest average of the diameters y of the island shapes is determined as MD.

### 1. Laminated Structure and Physical Property of Exterior Material for Electrical Storage Devices

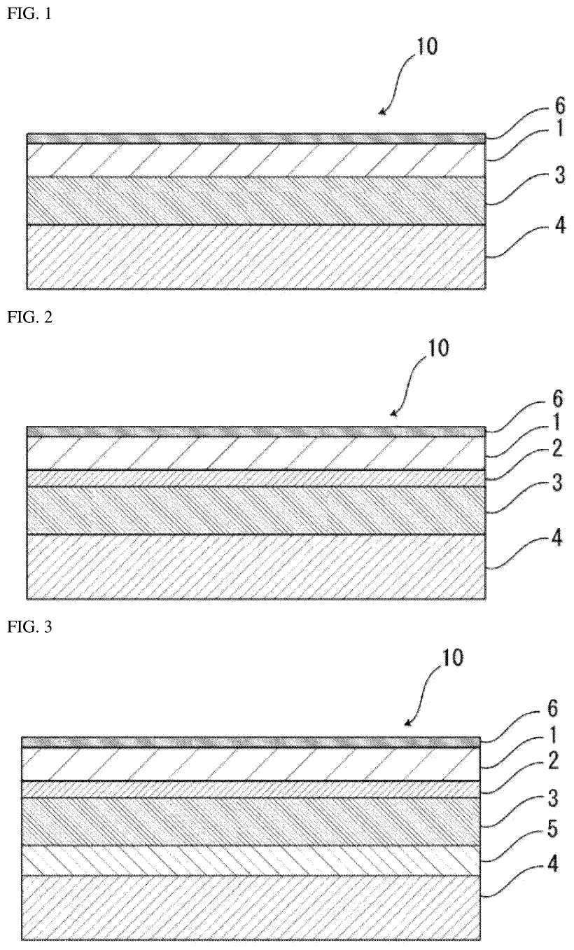

As shown in, for example, FIG. 1, an exterior material 10 for electrical storage devices according to the present disclosure includes a laminate including at least a surface coating layer 6, a base material layer 1, a barrier layer 3 and a heat-sealable resin layer 4 in this order from the outside. In the exterior material 10 for electrical storage devices, the surface coating layer 6 is an outermost layer, and the heat-sealable resin layer 4 is an innermost layer. In construction of an electrical storage device using the exterior material 10 for electrical storage devices and an electrical storage device element, the electrical storage device elements are put in a space formed by heat-sealing the peripheral portions of heat-sealable resin layers 4 of the exterior material 10 for electrical storage devices which face each other. In the laminate forming the exterior material 10 for electrical storage devices according to the present disclosure, the heat-sealable resin layer 4 is on the inner side with respect to the barrier layer 3, and the base material layer 1 is on the outer side with respect to the barrier layer 3.

As shown in, for example, FIGS. 2 and 3, the exterior material 10 for electrical storage devices may have an adhesive agent layer 2 between the base material layer 1 and the barrier layer 3 if necessary for the purpose of, for example, improving bondability between these layers. A colored layer may be provided between the base material layer 1 and the barrier layer 3 (not shown). As shown in, for example, FIG. 3, an adhesive layer 5 may be present between the barrier layer 3 and the heat-sealable resin layer 4 if necessary for the purpose of, for example, improving bondability between these layers.

The thickness of the laminate forming the exterior material 10 for electrical storage devices is not particularly limited, and is, for example, about 210 μm or less, preferably about 190 μm or less, about 180 μm or less, about 155 μm or less, or about 120 μm or less, from the viewpoint of cost reduction, energy density improvement, and the like. The thickness of the laminate forming the exterior material 10 for electrical storage devices is preferably about 35 μm or more, about 45 μm or more, or about 60 μm or more, from the viewpoint of maintaining the function of an exterior material for electrical storage devices, which is protection of an electrical storage device element. The thickness of the laminate forming the exterior material 10 for electrical storage devices is preferably in the range of, for example, about 35 to 210 μm, about 35 to 190 μm, about 35 to 180 μm, about 35 to 155 μm, about 35 to 120 μm, about 45 to 210 μm, about 45 to 190 μm, about 45 to 180 μm, about 45 to 155 μm, about 45 to 120 μm, about 60 to 210 μm, about 60 to 190 μm, about 60 to 180 μm, about 60 to 155 μm, or about 60 to 120 μm, and in particular, the thickness is preferably about 60 to 155 μm for reducing the weight and the thickness of the electrical storage device, and preferably about 155 to 190 μm for improving moldability.

In the exterior material 10 for electrical storage devices, the ratio of the total thickness of the surface coating layer 6, the base material layer 1, the adhesive agent layer 2 provided if necessary, the barrier layer 3, the adhesive layer 5 provided if necessary, and the heat-sealable resin layer 4 to the thickness (total thickness) of the laminate forming the exterior material 10 for electrical storage devices is preferably 90% or more, more preferably 95% or more, still more preferably 98% or more. As a specific example, when the exterior material 10 for electrical storage devices according to the present disclosure includes the surface coating layer 6, the base material layer 1, the adhesive agent layer 2, the barrier layer 3, the adhesive layer 5 and the heat-sealable resin layer 4, the ratio of the total thickness of these layers to the thickness (total thickness) of the laminate forming the exterior material 10 for electrical storage devices is preferably 90% or more, more preferably 95% or more, still more preferably 98% or more. In addition, when the exterior material 10 for electrical storage devices according to the present disclosure is a laminate including the surface coating layer 6, the base material layer 1, the adhesive agent layer 2, the barrier layer 3 and the heat-sealable resin layer 4, the ratio of the total thickness of these layers to the thickness (total thickness) of the laminate forming the exterior material 10 for electrical storage devices may be, for example, 80% or more, preferably 90% or more, more preferably 95% or more, still more preferably 98% or more.

In the exterior material for electrical storage devices according to the present disclosure, the surface coating layer contains a resin and a filler as described later. When a reflectance of the outer surface of the surface coating layer 6 is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less. The maximum value A of the reflectance in the light reception angle range of 55.0° or more and 65.0° or less represents the intensity of regular reflection, and the maximum value B of the reflectance in the light reception angle range of 70.0° or more and 80.0° or less represents the intensity of diffuse reflection. Consequently, it can be said that the exterior material for electrical storage devices, which has an A/B of 3.50 or less, thus does not give excessively intense regular reflection with respect to diffuse reflection, and has an excellent matte-toned appearance even in observation from various angles. Methods for measuring the physical properties of the exterior material for electrical storage devices according to the present disclosure using a goniophotometer will be described later.

From the viewpoint of more suitably exhibiting the effect of the present disclosure, the ratio (A/B) is preferably about 3.00 or less, more preferably about 1.70 or less, the lower limit of the ratio (A/B) is, for example, about 0.50 or more, and the ratio (A/B) is preferably in the range of about 0.50 to 3.50, about 0.50 to 3.00, or about 0.50 to 1.70.

From the viewpoint of further more suitably exhibiting the effect of the present disclosure, a relative intensity a of the maximum value A of the reflectance, when a maximum value Cf of a reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer, is defined as 100, is preferably about 2.0 or less, more preferably about 0.50 or less, the lower limit of the relative intensity a is, for example, about 0.050 or more, and the relative intensity a is preferably in the range of about 0.050 to 2.0, or about 0.050 to 0.50.

From the viewpoint of further more suitably exhibiting the effect of the present disclosure, a relative intensity b of the maximum value B of the reflectance, when the maximum value Cf of the reflectance of the standard plate black glass BK-7 is defined as 100, is preferably about 1.0 or less, more preferably about 0.30 or less, the lower limit of the relative intensity b is, for example, about 0.050 or more, and the relative intensity b is preferably in the range of about 0.050 to 1.0, or about 0.050 to 0.30.

From the viewpoint of further more suitably exhibiting the effect of the present disclosure, a total of relative intensities at angles in a light reception angle range of −38.0° or more and 88.0° or less for the outer surface of the surface coating layer 6, which are measured at light reception angle intervals of 0.1° under a condition of an incident light angle of 60° by using a goniophotometer, when the maximum value Cf of the reflectance of the standard plate black glass BK-7 is defined as 100, is preferably about 230 or less, more preferably about 120 or less, still more preferably about 89 or less, the lower limit of the total of relative intensities is, for example, about 10, and the total of relative intensities is preferably in the range of about 10 to 230, about 10 to 120, or about 10 to 89. The exterior material for electrical storage devices, in which the total of relative intensities at angles in the light reception angle range of −38.0° or more and 88.0° or less, which are measured at light reception angle intervals of 0.1°, is 230 or less, thus does not have an excessively high reflectance at each angle, and can have an excellent matte-toned appearance even in observation from various angles.

### <Measurement of Physical Properties of Surface Coating Layer by Goniophotometer>

Detailed methods for measuring the physical properties of the surface coating layer 6 of the exterior material 10 for electrical storage devices by using a goniophotometer are as follows.

Exterior materials for electrical storage devices are shaped into test pieces. A measuring device including a light source that generates light with which a test piece is irradiated, and a detector that detects light reflected by the test piece is prepared. As the measuring device, for example, goniophotometers GP-200 and GP-700 manufactured by MURAKAMI COLOR RESEARCH LABORATORY CO., LTD are used. The light source is a halogen lamp capable of outputting a power of 50 W at 12 V. The measuring device includes a dimming filter and a diaphragm located between the light source and the test piece or between the test piece and the detector.

First, a sample stage is angle-adjusted to an incidence angle of 60°. Next, an iris diaphragm is set to a diameter of 10.5 mm on the light source side, and an aperture diaphragm is set to a diameter of 9.1 mm on the detector side. Further, among sample pieces, samples having a low reflectance are fixed to the sample stage, and adjusted by a high voltage adjustment knob (HIGH VOLT ADJ) and a sensitivity adjustment dial (SENSITIVITY ADJ) so as to have a maximum reflectance of about 20 to 50% in a sensitivity check. For example, the high voltage (HIGH VOLT) is set to −520 V, and the sensitivity (SENSITIVITY) is set to 999 (maximum). Subsequently, standard plate black glass BK-7 (size 110×55 mm) is attached to the sample stage as a standard plate, and a dimming filter to be attached on the light source side is selected such that the maximum reflectance is about 50 to 90% in the sensitivity check. As the dimming filter, those of 1.0%, 10.0% and 50.0% are used alone or in combination. As the dimming filter, for example, those of 1.0% and 50.0% are used in combination. As the standard black glass BK-7, a sample with a refractive index of 1.518 is used. If the standard plate black glass BK-7 with a refractive index of 1.518 is not available, standard plate black glass BK-7 whose refractive index is as close to 1.518 as possible is used for the measurement, and the physical properties are obtained as values converted into those when the standard plate black glass BK-7 with a refractive index of 1.518. A measurement step of allowing light from a light source to enter standard plate black glass, detecting light reflected by a surface of the standard plate black glass (hereinafter, also referred to as reflected light) with a detector, and measuring the light reflectance is carried out. By changing the angle of the detector, the intensity of the reflected light is measured at intervals of 0.1°. In the case of standard plate black glass, only regular reflected light at an angle of near 60° is detected, and therefore the intensity of reflected light emitted from the surface of the standard plate black glass at an angle of 45.0 to 75.0° is measured at intervals of 0.1°. The reflectance of the standard black glass is measured before and after the measurement of the sample piece, and the maximum value of the reflectance C and the maximum reflectance angle at this time are recorded.

Next, sample pieces are prepared. The sample piece is cut into a rectangular shape of 5 cm×6 cm, and fixed on a black plate of 6 cm×7 cm with a double-sided tape, followed by fixation of the periphery with a black tape. Further, the black plate on which the sample piece is fixed is fixed to a sample stage. A measurement step of allowing light from a light source to enter test piece, detecting light reflected by a surface of the test piece (hereinafter, also referred to as reflected light) with a detector, and measuring the light reflectance is carried out. A dimming filter to be attached on the light source side is selected such that the maximum reflectance is about 10 to 90% in the sensitivity check of the test piece. As the dimming filter, those of 1.0%, 10.0% and 50.0% are used alone or in combination. By changing the angle of the detector, the intensity of the reflected light emitted from the surface of the test piece at a light reception angle of −40.0° to 90.0° is measured at intervals of 0.1°. After completion of the measurement of the sample piece and the standard plate black glass, analysis is performed.

The analysis is performed as follows. First, the maximum reflectance angle of the standard black glass is set to 60.0°, and the angle of the sample piece is corrected. For example, when the maximum reflectance angle of the standard black glass is 61.0°, the sample piece measurement angle is shifted by 1.0°. Specifically, the sample piece measurement angle is corrected from 61.0° to 60.0°, and the sample piece measurement angle is corrected from 62.0° to 61.0°. Next, the maximum intensity between 55.0° and 65.0° after correction of the sample piece is read. This value is defined as a maximum value A. Further, the maximum intensity between 70.0° and 80.0° after correction of the sample piece is read. This value is defined as a maximum value B.

A value obtained by dividing the maximum value A by the maximum value B is defined as a ratio of the maximum value A of the reflectance in a light reception angle range of 70.0° or more and 80.0° or less to the maximum value B of the reflectance in a light reception angle range of 55.0° or more and 65.0° or less.

Next, the reflectances A and B of the sample piece are converted to determine relative intensities a and b with respect to the maximum value Cf of the reflectance of the surface of the standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer. First, for the sample piece measured using the dimming filter, the maximum values Af and Bf of the reflectance after angle correction and after filter correction, respectively, are determined. In the filter correction of the sample measured using the dimming filter, values obtained by dividing reflectances A and B by 0.100 are maximum values Af and Bf after filter correction for A and B, respectively, when a 10.0% dimming filter is used, for example. Next, a filter correction value of the standard black glass BK-7 is determined. For example, when a 1.0% dimming filter and a 50.0% dimming filter are used, a value obtained by dividing the maximum value of the reflectance C of the standard black glass BK-7 by 0.010, and dividing the quotient by 0.50 is defined as a filter correction value Cf of the standard black glass BK-7. The relative intensity a of the maximum value of the reflectance A at a light reception angle of 55.0° to 65.0° when the maximum value of the reflectance Cf of the black glass BK-7 is defined as 100 is “(A/Cf)×100” for samples measured without using the diming filter, and “(Af/Cf)×100” for samples measured using the dimming filter. The relative intensity b of the maximum value B of the reflectance at a light reception angle of 70.0° to 80.0° when the maximum value of the reflectance Cf of the black glass BK-7 is defined as 100 is “(B/Cf)×100” for samples measured without using the diming filter, and “(Bf/Cf)×100” for samples measured using the dimming filter.

Next, a total E of reflectances of the sample piece (after angle correction) in a light reception angle range of −38.0° to 88.0° is determined. Specifically, the total value E is determined by adding up all the reflectances measured at a light reception angle of −38.0 to 88.0° and in steps of 0.1°. For the sample piece measured using the dimming filter, reflectances obtained at all the angles are filter-corrected, followed by determination of the total value Ef. Intensities obtained at all the angles may be filter-corrected, followed by determination of the total value Ef, or the total value E of reflectances at a light reception angle of −38.0° to 88.0° after angle correction may be determined, followed by correction of the dimming filter. Specifically, for example, when a 10.0% dimming filter is used, a value obtained by dividing the total value E in the light reception angle range of −38.0° to 88.0° by 0.100 is defined as the total Ef of reflectances at a light reception angle of −38.0° to 88.0° after angle correction and after filter correction. Further, a total of relative intensities with respect to the maximum value Cf of the reflectance of the standard plate black glass BK-7 is determined. The total of relative intensities at light reception angles of −38.0° to 88.0° when the maximum value Cf of the reflectance of the black glass BK-7 is defined as 100 is “(E/Cf)×100” for samples measured without using the diming filter, and “(Ef/Cf)×100” for samples measured using the dimming filter.

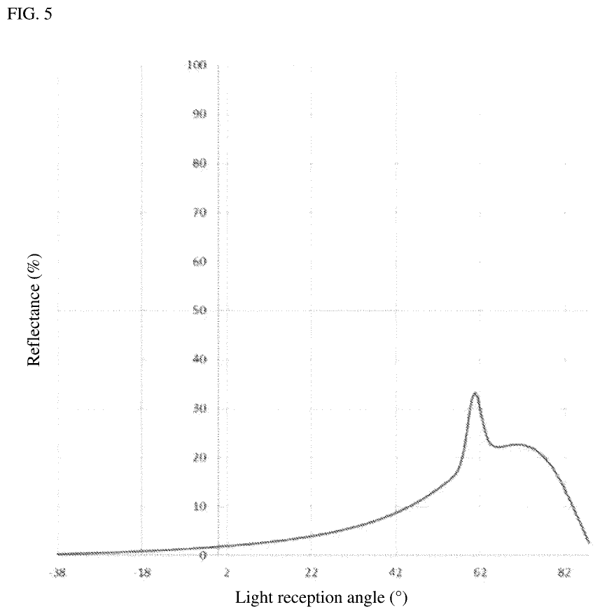

FIG. 5 shows a schematic diagram of a graph obtained using a goniophotometer represents the reflectance (%)).

As will be described later, the various physical properties of the exterior material for electrical storage devices according to the present disclosure with a goniophotometer can be adjusted by, for example, the composition of a resin composition for forming the surface coating layer 6 (e.g., types and contents of the resin and the filler, and the size of the filler), the method for forming the surface coating layer 6 (e.g., coating method, and curing conditions), the thickness of the surface coating layer 6, and the like.

An exterior material 10 for electrical storage devices according to the present disclosure, in which when a reflectance of the outer surface of the surface coating layer 6 is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less, thus does not give excessively intense regular reflection with respect to diffuse reflection, and has a uniform and excellent matte-toned appearance even in observation from various angles. It is preferable that the appearance of the exterior material 10 for electrical storage devices according to the present disclosure has a color shade of white, red, blue, yellow, silver, gray, brown, black or the like when observed from the outside. Even when having a color shade, the exterior material for electrical storage devices can have an excellent matte-toned appearance and a uniform color tone even in observation from various angles. The appearance of the exterior material 10 for electrical storage devices according to the present disclosure is more preferably black when observed from the outside. When the appearance of the exterior material for electrical storage devices according to the present disclosure is black, it has an excellent matte-toned black design even in observation of the outer surface from various angles, and can exhibit a high design property. As will be described later, for example, when the adhesive agent layer 2 contains a black colorant (e.g., carbon black), the appearance of the exterior material 10 for electrical storage devices according to the present disclosure can be black when observed from the outside.

### 2. Layers Forming Exterior Material for Electrical Storage Devices

### [Surface Coating Layer 6]

The exterior material 10 for electrical storage devices according to the present disclosure includes the surface coating layer 6 on the base material layer 1 (on the base material layer 1 on a side opposite to the barrier layer 3) for imparting a matte-toned design (matte) to the outer surface as one of purposes. The surface coating layer 6 is a layer located on the outermost layer of the exterior material 10 for electrical storage devices when the electrical storage device is constructed using the exterior material for electrical storage devices. That is, the surface coating layer 6 forms the outer surface of the exterior material 10 for electrical storage devices according to the present disclosure.

The surface coating layer 6 contains a resin and a filler. That is, it is preferable that the surface coating layer 6 can be formed from a resin composition containing a resin and a filler. As described above, the exterior material 10 for electrical storage devices according to the present disclosure is characterized in that the ratio (A/B) is 3.50 or less when the measurement is performed on the outer surface of the surface coating layer by using a goniophotometer, and preferably further has the various physical properties described above.

The various physical properties of the exterior material for electrical storage devices according to the present disclosure with a goniophotometer can be adjusted by, for example, the composition of a resin composition for forming the surface coating layer 6 (e.g., types and contents of the resin and the filler, and the size of the filler), the method for forming the surface coating layer 6 (e.g., coating method, and curing conditions), the thickness of the surface coating layer 6, and the like. More specifically, for example, when an organic filler and an inorganic filler are used in combination for the surface coating layer 6, the content of the inorganic filler is preferably higher than that of the organic filler. When the content of the inorganic filler higher than that of the organic filler, surface reflection of the surface coating layer 6 can be suppressed, and internal scattering inside the surface coating layer can be increased to enhance diffuse reflection, so that the various physical properties can be adjusted. It is more preferable that the surface coating layer 6 does not contain an organic filler and contains only an inorganic filler. The type of the inorganic filler is preferably silica.

Examples of the resin that is contained in the surface coating layer 6 include resins such as polyvinylidene chloride, polyester, polyamide, epoxy resin, acrylic resin, fluororesin, polyurethane, silicone resin and phenol resin, and modified products of these resins. The resin may be a copolymer of these resins or a modified product of the copolymer. A mixture of these resins may be used. The resin is preferably a curable resin. That is, it is preferable that the surface coating layer 6 includes a cured product of a resin composition containing a curable resin and a filler.

When the resin forming the surface coating layer 6 is a curable resin, the resin may be any of a one-liquid curable type and a two-liquid curable type, and is preferably a two-liquid curable type. Examples of the two-liquid curable resin include two-liquid curable polyurethane, two-liquid curable polyester and two-liquid curable epoxy resins. Of these, two-liquid curable polyurethane is preferable.

Examples of the two-liquid curable polyurethane include polyurethane which contains a first component containing a polyol compound and a second component containing an isocyanate compound. The polyurethane is preferably a two-liquid curable polyurethane adhesive having polyol such as polyester polyol, polyether polyol or acrylic polyol as a first component, and aromatic or aliphatic polyisocyanate as a second component. Examples of the polyurethane include polyurethane containing an isocyanate compound and a polyurethane compound obtained by reacting a polyol compound with an isocyanate compound in advance. Examples of the polyurethane include polyurethane containing a polyurethane compound and a polyurethane compound obtained by reacting a polyol compound with an isocyanate compound in advance. Examples of the polyurethane include polyurethane obtained by reacting a polyol compound with an isocyanate compound to form a polyurethane compound in advance, and reacting the polyurethane compound with moisture in the air or the like. It is preferable that polyester polyol having a hydroxyl group in the side chain in addition to a hydroxyl group at the end of the repeating unit is used as the polyol compound. Examples of the second component include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g., a trimer) as the polyisocyanate compound. Examples of the multimer include adducts, biurets, and nurates. The aliphatic isocyanate-based compound is an isocyanate having an aliphatic group and having no aromatic ring, the alicyclic isocyanate-based compound is an isocyanate having an alicyclic hydrocarbon group, and the aromatic isocyanate-based compound is an isocyanate having an aromatic ring. Since the surface coating layer 6 is formed of polyurethane, excellent electrolytic solution resistance is imparted to the exterior material for electrical storage devices.

The surface coating layer 6 contains a filler. A matte-toned design can be imparted to the surface coating layer 6 when a filler is contained. The filler is preferably particles. Examples of the filler include inorganic fillers, organic fillers, inorganic particles, and organic particles. When the surface coating layer 6 contains a filler, the surface coating layer 6 may contain one filler or two or more fillers. It is also preferable to use an inorganic filler and an organic filler in combination. The shape of the filler is not particularly limited, and examples thereof include a spherical shape, a fibrous shape, a plate shape, an amorphous shape and a scaly shape.

The average particle diameter of the filler is not particularly limited, and is, for example, about 0.01 μm or more, preferably about 0.1 μm or more, more preferably about 1 μm or more, and preferably about 100 μm or less, more preferably about 50 μm or less, still more preferably about 5 μm or less, and is preferably in the range of about 0.01 to 100 μm, about 0.01 to 50 μm, about 0.01 to 5 μm, about 0.1 to 100 μm, about 0.1 to 50 μm, about 0.1 to 5 μm, about 1 to 100 μm, about 1 to 50 μm, or about 1 to 5 μm, from the viewpoint of imparting a matte-toned design to the exterior material 10 for electrical storage devices. The average particle diameter of the filler is a median diameter measured by a laser diffraction/scattering particle diameter distribution measuring apparatus. The average particle diameter of the filler is preferably equal to or less than the thickness of the surface coating layer 6.

The inorganic filler is not particularly limited as long as the surface coating layer 6 have a matte tone, and examples thereof include particles of silica, talc, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, gold, aluminum, copper and nickel. Of these, silica particles are particularly preferable.

The inorganic filler and the organic filler may be used in combination, or may be used alone. In the present disclosure, it is preferable that the filler contains at least an inorganic filler.

The organic filler is not particularly limited as long as the surface coating layer 6 can have a matte tone, and examples thereof include particles of nylon, polyacrylate, polystyrene, polyethylene, benzoguanamine and crosslinked products thereof.

From the viewpoint of suitably exhibiting the effect of the present disclosure, the amount of the filler based on 100 parts by mass of the resin in the resin composition for forming the surface coating layer 6 is preferably about 1 part by mass or more, more preferably about 5 parts by mass or more, and preferably about 500 parts by mass or less, more preferably about 100 parts by mass or less, still more preferably about 50 parts by mass or less, and is preferably in the range of about 1 to 500 parts by mass, about 1 to 100 parts by mass, about 1 to 50 parts by mass, about 5 to 500 parts by mass, about 5 to 100 parts by mass, or about 5 to 50 parts by mass. When the inorganic filler and the organic filler are used in combination, the amount of the organic filler is preferably about 1 to 1000 parts by mass, more preferably about 1 to 100 parts by mass, and still more preferably about 1 to 50 parts by mass based on 100 parts by mass of the inorganic filler. It is more preferable that the filler does not include an organic filler and is composed only of an inorganic filler.

If necessary, the surface coating layer 6 may further contain additives such as a slipping agent and a colorant as described later, an anti-blocking agent, a flame retardant, an antioxidant, a tackifier and an anti-static agent on at least one of the surface and the inside of the surface coating layer 6 according to the functionality and the like to be imparted to the surface coating layer 6 and the surface thereof.

When the surface coating layer 6 contains a colorant, a known colorant such as pigments and dyes can be used as the colorant. The colorants may be used alone, or may be used in combination of two or more thereof. Specific examples of the colorant contained in the surface coating layer 6 include the same colorants as those exemplified in the section [Adhesive agent Layer 2]. The preferred content of the colorant contained in the surface coating layer 6 is also the same as the content described in the section [Adhesive agent Layer 2].

The method for forming the surface coating layer 6 is not particularly limited, and examples thereof include a method in which a resin composition for forming the surface coating layer 6 is applied. When the additive is added to the surface coating layer 6, a resin mixed with the additive may be applied. As described above, the various physical properties of the exterior material for electrical storage devices according to the present disclosure with a goniophotometer can be adjusted by the composition of a resin composition for forming the surface coating layer 6 (e.g., types and contents of the resin and the filler, and the size of the filler), the method for forming the surface coating layer 6 (e.g., coating method, and curing conditions), the thickness of the surface coating layer 6, and the like. Examples of the coating method include gravure printing using a gravure plate, a die coater, a bar coater, and the like. More specifically, there are two types of plate making methods with gravure plates, “laser plate making” and “engraving plate making”. Laser plate making, which is a method in which copper plate is corroded with chemicals to form a pattern, may be called a corrosion plate. Engraving plate making, which is a method in which with a diamond stylus vibrated by electric signals, a copper plate surface is directly chipped to form a pattern, may be called an engraving plate. The die coater is able to perform closed-type high-precision coating, where uniform coating can be performed by a manifold optimized by fluid analysis using coating solution viscosity data. In the bar coater, a coating surface produced from a high-precision polished edge can be coated very smoothly and uniformly.

From the viewpoint of the matte-toned design, the thickness of the surface coating layer 6 is preferably 0.5 μm or more, more preferably 1 μm or more, and preferably 10 μm or less, more preferably 5 μm or less, and is preferably in the range of about 0.5 to 10 μm, about 0.5 to 5 μm, about 1 to 10 μm, or about 1 to 5 μm.

In the present disclosure, it is preferable that a slipping agent is present on the surface of the surface coating layer 6 and/or inside the surface coating layer 6 from the viewpoint of enhancing the moldability of the exterior material for electrical storage devices. The slipping agent is not particularly limited, and is preferably an amide-based slipping agent. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide. Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N′-dioleyladipic acid amide, and N,N′-dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N′-distearylisophthalic acid amide. The slipping agents may be used alone, or may be used in combination of two or more thereof, and are preferably used in combination of two or more thereof.

When the slipping agent is present on the surface of the surface coating layer 6, the amount of the slipping agent present is not particularly limited, and is, for example, about 3 mg/m2 or more, preferably about 4 mg/m2 or more, still more preferably about 5 mg/m2 or more. The amount of the slipping agent present on the surface of the surface coating layer 6 is, for example, about 15 mg/m2 or less, preferably about 14 mg/m2 or less, still more preferably about 10 mg/m2 or less. The amount of the slipping agent present on the surface of the surface coating layer 6 is preferably in the range of about 3 to 15 mg/m2, about 3 to 14 mg/m2, about 3 to 10 mg/m2, about 4 to 15 mg/m2, about 4 to 14 mg/m2, about 4 to 10 mg/m2, about 5 to 15 mg/m2, about 5 to 14 mg/m2, or about 5 to 10 mg/m².

The slipping agent present on the surface of the surface coating layer 6 may be one obtained by exuding the slipping agent contained in a resin for forming the surface coating layer 6, or one obtained by applying the slipping agent to the surface of the surface coating layer 6.

### [Base Material Layer 1]

In the present disclosure, the base material layer 1 is a layer provided for the purpose of, for example, exhibiting a function as a base material of the exterior material for electrical storage devices. The base material layer 1 is located on the outer layer side of the exterior material for electrical storage devices.

The material for forming the base material layer 1 is not particularly limited as long as it has a function as a base material, i.e., at least insulation quality. The base material layer 1 can be formed using, for example, a resin, and the resin may contain additives described later.

When the base material layer 1 is formed of a resin, the base material layer 1 may be, for example, a resin film formed of a resin, or may be formed by applying a resin. When the base material layer 1 is formed from a resin film, a resin film formed in advance may be used as the base material layer 1 in manufacturing of the exterior material 10 for electrical storage devices according to the present disclosure by laminating the base material layer 1 with the barrier layer 3. A resin for forming the base material layer 1 may be formed into a film on the surface of the barrier layer 3 or the like by extrusion molding, coating or the like to obtain the base material layer 1 formed of a resin film. The resin film may be an unstretched film or a stretched film. Examples of the stretched film include uniaxially stretched films and biaxially stretched films, and biaxially stretched films are preferable. Examples of the stretching method for forming a biaxially stretched film include a sequential biaxial stretching method, an inflation method, and a simultaneous biaxial stretching method. Examples of the method for applying a resin include a roll coating method, a gravure coating method and an extrusion coating method.

Examples of the resin that forms the base material layer 1 include resins such as polyester, polyamide, polyolefin, epoxy resin, acrylic resin, fluororesin, polyurethane, silicone resin and phenol resin, and modified products of these resins. The resin that forms the base material layer 1 may be a copolymer of these resins or a modified product of the copolymer. A mixture of these resins may be used.

It is preferable that the base material layer 1 contains any of these resins as a main component, more preferably polyester or polyamide as a main component. Here, the main component means a resin component, the content ratio of which is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the base material layer 1. For example, the phrase “the base material layer 1 contains polyester or polyamide as a main component” means that the content ratio of polyester or polyamide is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the base material layer 1.

Of these resins, polyester and polyamide are preferable as resins that form the base material layer 1.

Specific examples of the polyester include polyethylene terephthalate, polybutylene terephthalate, polyethylene naphthalate, polybutylene naphthalate, polyethylene isophthalate, and copolyesters. Examples of the copolyester include copolyesters having ethylene terephthalate as a main repeating unit. Specific examples thereof include copolymer polyesters that are polymerized with ethylene isophthalate and include ethylene terephthalate as a main repeating unit (hereinafter, abbreviated as follows after polyethylene (terephthalate/isophthalate)), polyethylene (terephthalate/adipate), polyethylene (terephthalate/sodium sulfoisophthalate), polyethylene (terephthalate/sodium isophthalate), polyethylene (terephthalate/phenyl-dicarboxylate) and polyethylene (terephthalate/decane dicarboxylate). These polyesters may be used alone, or may be used in combination of two or more thereof.

Specific examples of the polyamide include polyamides such as aliphatic polyamides such as nylon 6, nylon 66, nylon 610, nylon 12, nylon 46, and copolymers of nylon 6 and nylon 66; hexamethylenediamine-isophthalic acid-terephthalic acid copolymerization polyamides containing a structural unit derived from terephthalic acid and/or isophthalic acid, such as nylon 6I, nylon 6T, nylon 6IT and nylon 6I6T (I denotes isophthalic acid and T denotes terephthalic acid), and polyamides containing aromatics, such as polyamide MXD6 (polymethaxylylene adipamide); alicyclic polyamides such as polyamide PACM6 (polybis(4-aminocyclohexyl) methaneadipamide; polyamides copolymerized with a lactam component or an isocyanate component such as 4,4′-diphenylmethane-diisocyanate, and polyester amide copolymers and polyether ester amide copolymers as copolymers of a copolymerization polyamide and a polyester or a polyalkylene ether glycol; and copolymers thereof. These polyamides may be used alone, or may be used in combination of two or more thereof.

The base material layer 1 contains preferably at least one of a polyester film, a polyamide film and a polyolefin film, preferably at least one of a stretched polyester film, a stretched polyamide film and a stretched polyolefin film, still more preferably at least one of a stretched polyethylene terephthalate film, a stretched polybutylene terephthalate film, a stretched nylon film and a stretched polypropylene film, even more preferably at least one of a biaxially stretched polyethylene terephthalate film, a biaxially stretched polybutylene terephthalate film, a biaxially stretched nylon film, and a biaxially stretched polypropylene film.

The base material layer 1 may be a single layer, or may include two or more layers. When the base material layer 1 includes two or more layers, the base material layer 1 may be a laminate obtained by laminating resin films with an adhesive or the like, or a resin film laminate obtained by co-extruding resins to form two or more layers. The resin film laminate obtained by co-extruding resins to form two or more layers may be used as the base material layer 1 in an unstretched state, or may be uniaxially stretched or biaxially stretched and used as the base material layer 1.

Specific examples of the resin film laminate with two or more layers in the base material layer 1 include laminates of a polyester film and a nylon film, nylon film laminates with two or more layers, and polyester film laminates with two or more layers. Laminates of a stretched nylon film and a stretched polyester film, stretched nylon film laminates with two or more layers, and stretched polyester film laminates with two or more layers are preferable. For example, when the base material layer 1 is a resin film laminate with two layers, the base material layer 1 is preferably a laminate of a polyester resin film and a polyester resin film, a laminate of a polyamide resin film and a polyamide resin film, or a laminate of a polyester resin film and a polyamide resin film, more preferably a laminate of a polyethylene terephthalate film and a polyethylene terephthalate film, a laminate of a nylon film and a nylon film, or a laminate of a polyethylene terephthalate film and a nylon film. Since the polyester resin is hardly discolored even in the case where for example, an electrolytic solution is deposited on the surface, it is preferable that the polyester resin film is located at the outermost layer of the base material layer 1 when the base material layer 1 is a resin film laminate with two or more layers.

When the base material layer 1 is a resin film laminate with two or more layers, the two or more resin films may be laminated with an adhesive interposed therebetween. Specific examples of the preferred adhesive include the same adhesives as those exemplified for the adhesive agent layer 2 described later. The method for laminating a resin film having two or more layers is not particularly limited, and a known method can be employed. Examples thereof include a dry lamination method, a sand lamination method, an extrusion lamination method and a thermal lamination method, and a dry lamination method is preferable. When the resin film is laminated by a dry lamination method, it is preferable to use a polyurethane adhesive as the adhesive. Here, the thickness of the adhesive is, for example, about 2 to 5 μm. In addition, the lamination may be performed with an anchor coat layer formed on the resin film. Examples of the anchor coat layer include the same adhesives as those exemplified for the adhesive agent layer 2 described later. Here, the thickness of the anchor coat layer is, for example, about 0.01 to 1.0 μm.

Additives such as a flame retardant, an antiblocking agent, an antioxidant, a light stabilizer, a tackifier and an antistatic agent may be present on at least one of the surface of the base material layer 1 and/or inside the base material layer 1. The additives may be used alone, or may be used in combination of two or more thereof.

The thickness of the base material layer 1 is not particularly limited as long as a function as a base material is performed, and the thickness of the base material layer 1 is, for example, about 3 μm, preferably about 10 μm. The thickness of the base material layer 1 is, for example, about 50 μm or less, preferably 35 μm or less, 11 μm or less, or 8 μm or less. The thickness of the base material layer 1 is preferably in the range of about 3 to 50 μm, about 3 to 35 μm, about 3 to 11 m, about 3 to 8 μm, about 10 to 50 μm, or about 10 to 35 μm, and in particular, the thickness is preferably about 3 to 35 μm, about 3 to 11 μm, or about 3 to 8 μm for reducing the weight and the thickness of the electrical storage device, and preferably about 35 to 50 μm for improving moldability. When the base material layer 1 is a resin film laminate with two or more layers, the thickness of the resin film forming each layer is not particularly limited, and is, for example, about 2 μm, preferably about 10 μm or more, or about 18 μm or more. The thickness of the resin film forming each layer is, for example, about 33 μm or less, preferably about 28 μm or less, about 23 μm or less, about 18 μm or less, 11 μm, or 8 μm or less. The thickness of the resin film forming each layer is about 2 to 33 μm, about 2 to 28 μm, about 2 to 23 μm, about 2 to 18 μm, about 10 to 33 μm, about 10 to 28 μm, about 10 to 23 μm, about 10 to 18 μm, about 18 to 33 μm, about 18 to 28 μm, about 18 to 23 μm, about 2 to 11 μm, or about 2 to 8 μm.

### [Adhesive Agent Layer 2]

In the exterior material for electrical storage devices of the present disclosure, the adhesive agent layer 2 is a layer provided between the base material layer 1 and the barrier layer 3 if necessary for the purpose of enhancing bondability between these layers.

The adhesive agent layer 2 is formed from an adhesive capable of bonding the base material layer 1 and the barrier layer 3. The adhesive used for forming the adhesive agent layer 2 is not limited, and may be any of a chemical reaction type, a solvent volatilization type, a heat melting type, a heat pressing type, and the like. The adhesive agent may be a two-liquid curable adhesive (two-liquid adhesive), a one-liquid curable adhesive (one-liquid adhesive), or a resin that does not involve curing reaction. The adhesive agent layer 2 may be a single layer or a multi-layer.

Specific examples of the adhesive component contained in the adhesive include polyester such as polyethylene terephthalate, polybutylene terephthalate, polyethylene naphthalate, polybutylene naphthalate, polyethylene isophthalate and copolyester; polyether; polyurethane; epoxy resins; phenol resins; polyamides such as nylon 6, nylon 66, nylon 12 and copolymerized polyamide; polyolefin-based resins such as polyolefins, cyclic polyolefins, acid-modified polyolefins and acid-modified cyclic polyolefins; cellulose; (meth)acrylic resins; polyimide; polycarbonate; amino resins such as urea resins and melamine resins; rubbers such as chloroprene rubber, nitrile rubber and styrene-butadiene rubber; and silicone resins. These adhesive components may be used alone, or may be used in combination of two or more thereof. Of these adhesive components, polyurethane-based adhesives are preferable. In addition, the adhesive strength of these resins used as adhesive components can be increased by using an appropriate curing agent in combination. As the curing agent, appropriate one is selected from polyisocyanate, a polyfunctional epoxy resin, an oxazoline group-containing polymer, a polyamine resin, an acid anhydride and the like according to the functional group of the adhesive component.

Examples of the polyurethane adhesive include polyurethane adhesives containing a main component (first component) containing a polyol compound and a curing agent (second component) containing an isocyanate compound. The polyurethane adhesive is preferably a two-liquid curable polyurethane adhesive having polyol such as polyester polyol, polyether polyol or acrylic polyol as a main component (first component), and aromatic or aliphatic polyisocyanate as a curing agent (second component). Examples of the polyurethane adhesive include polyurethane adhesives containing an isocyanate compound and a polyurethane compound obtained by reacting a polyol compound with an isocyanate compound in advance. Examples of the polyurethane adhesive include polyurethane adhesives containing a polyol compound and a polyurethane compound obtained by reacting a polyol compound with an isocyanate compound in advance. Examples of the polyurethane adhesive include polyurethane adhesives obtained by reacting a polyol compound with an isocyanate compound to form a polyurethane compound in advance, and reacting the polyurethane compound with moisture in the air or the like. It is preferable that polyester polyol having a hydroxyl group in the side chain in addition to a hydroxyl group at the end of the repeating unit is used as the polyol compound. Examples of the curing agent (second component) include aliphatic, alicyclic, aromatic and araliphatic isocyanate-based compounds. Examples of the isocyanate-based compound include hexamethylene diisocyanate (HDI), xylylene diisocyanate (XDI), isophorone diisocyanate (IPDI), hydrogenated XDI (H6XDI), hydrogenated MDI (H 12 MDI), tolylene diisocyanate (TDI), diphenylmethane diisocyanate (MDI) and naphthalene diisocyanate (NDI). Examples of the isocyanate-based compound also include polyfunctional isocyanate-modified products of one or more of these diisocyanates can be mentioned. It is also possible to use a multimer (e.g., a trimer) as the polyisocyanate compound. Examples of the multimer include adducts, biurets, and nurates. Since the adhesive agent layer 2 is formed of a polyurethane adhesive, excellent electrolytic solution resistance is imparted to the exterior material for electrical storage devices, so that peeling of the base material layer 1 is suppressed even if the electrolytic solution is deposited on the side surface.

Other components may be added to the adhesive agent layer 2 as long as bondability is not inhibited, and the adhesive agent layer 2 may contain a colorant, a thermoplastic elastomer, a tackifier, a filler, and the like. When the adhesive agent layer 2 contains a colorant, the exterior material for electrical storage devices can be colored. As the colorant, known colorants such as pigments and dyes can be used. The colorants may be used alone, or may be used in combination of two or more thereof.

The type of pigment is not particularly limited as long as the bondability of the adhesive agent layer 2 is not impaired. Examples of the organic pigment include azo-based pigments, phthalocyanine-based pigments, quinacridone-based pigments, anthraquinone-based pigments, dioxazine-based pigments, indigothioindigo-based pigments, perinone-perylene-based pigments, isoindolenine-based pigments and benzimidazolone-based pigments. Examples of the inorganic pigment include carbon black-based pigments, titanium oxide-based pigments, cadmium-based pigments, lead-based pigments, chromium-based pigments and iron-based pigments, and also fine powder of mica (mica) and fish scale foil.

Of the colorants, carbon black is preferable for the purpose of, for example, blackening the appearance of the exterior material for electrical storage devices. In the appearance of the exterior material 10 for electrical storage devices according to the present disclosure, it is particularly preferable that the adhesive agent layer 2 contains a black colorant, and the appearance is black when observed from the outside.

The average particle diameter of the pigment is not particularly limited, and is, for example, about 0.05 to 5 μm, preferably about 0.08 to 2 μm. The average particle diameter of the pigment is a median diameter measured by a laser diffraction/scattering particle diameter distribution measuring apparatus.

The content of the pigment in the adhesive agent layer 2 is not particularly limited as long as the exterior material for electrical storage devices is colored, and the content is, for example, about 5 to 60 mass %, preferably 10 to 40 mass %.

The thickness of the adhesive agent layer 2 is not particularly limited as long as the base material layer 1 and the barrier layer 3 can be bonded to each other, and the thickness is, for example, about 1 μm or more, or about 2 μm or more. The thickness of the adhesive agent layer 2 is, for example, about 10 μm or less, or about 5 μm or less. The thickness of the adhesive agent layer 2 is preferably in the range of about 1 to 10 μm, about 1 to 5 μm, about 2 to 10 μm, or about 2 to 5 μm.

### [Colored Layer]

The colored layer is a layer provided between the base material layer 1 and the barrier layer 3 if necessary (not shown). When the adhesive agent layer 2 is present, the colored layer may be provided between the base material layer 1 and the adhesive agent layer 2 or between the adhesive agent layer 2 and the barrier layer 3. The colored layer may be provided outside the base material layer 1. By providing the colored layer, the exterior material for electrical storage devices can be colored.

The colored layer can be formed by, for example, applying an ink containing a colorant to the surface of the base material layer 1, or the surface of the barrier layer 3. As the colorant, known colorants such as pigments and dyes can be used. The colorants may be used alone, or may be used in combination of two or more thereof.

Specific examples of the colorant contained in the colored layer include the same colorants as those exemplified in the section [Adhesive agent layer 2].

### [Barrier Layer 3]

In the exterior material for electrical storage devices, the barrier layer 3 is a layer which suppresses at least ingress of moisture.

Examples of the barrier layer 3 include metal foils, deposited films and resin layers having a barrier property. Examples of the deposited film include metal deposited films, inorganic oxide deposited films and carbon-containing inorganic oxide deposited films, and examples of the resin layer include those of polyvinylidene chloride, fluorine-containing resins such as polymers containing chlorotrifluoroethylene (CTFE) as a main component, polymers containing tetrafluoroethylene (TFE) as a main component, polymers having a fluoroalkyl group, and polymers containing a fluoroalkyl unit as a main component, and ethylene vinyl alcohol copolymers. Examples of the barrier layer 3 include resin films provided with at least one of these deposited films and resin layers. A plurality of barrier layers 3 may be provided. Preferably, the barrier layer 3 contains a layer formed of a metal material. Specific examples of the metal material forming the barrier layer 3 include aluminum alloys, stainless steel, titanium steel and steel sheets. When the metal material is used as a metal foil, it is preferable that the metal material includes at least one of an aluminum alloy foil and a stainless steel foil.

The aluminum alloy is more preferably a soft aluminum alloy foil formed of, for example, an annealed aluminum alloy from the viewpoint of improving the moldability of the exterior material for electrical storage devices, and is preferably an aluminum alloy foil containing iron from the viewpoint of further improving the moldability. In the aluminum alloy foil containing iron (100 mass %), the content of iron is preferably 0.1 to 9.0 mass %, more preferably 0.5 to 2.0 mass %. When the content of iron is 0.1 mass % or more, it is possible to obtain an exterior material for electrical storage devices which has more excellent moldability. When the content of iron is 9.0 mass % or less, it is possible to obtain an exterior material for electrical storage devices which is more excellent in flexibility. Examples of the soft aluminum alloy foil include aluminum alloy foils having a composition specified in JIS H4160: 1994 A8021H-O, JIS H4160: 1994 A8079H-O, JIS H4000: 2014 A8021P-O, or JIS H4000: 2014 A8079P-O. If necessary, silicon, magnesium, copper, manganese or the like may be added. Softening can be performed by annealing or the like.

Examples of the stainless steel foil include austenitic stainless steel foils, ferritic stainless steel foils, austenitic/ferritic stainless steel foils, martensitic stainless steel foils and precipitation-hardened stainless steel foils. From the viewpoint of providing an exterior material for electrical storage devices which is further excellent in moldability, it is preferable that the stainless steel foil is formed of austenitic stainless steel.

Specific examples of the austenite-based stainless steel foil include SUS 304 stainless steel, SUS 301 stainless steel and SUS 316L stainless steel, and of these, SUS 304 stainless steel is especially preferable.

When the barrier layer 3 is a metal foil, the barrier layer 3 may perform a function as a barrier layer suppressing at least ingress of moisture, and has a thickness of, for example, about 9 to 200 μm. The thickness of the barrier layer 3 is preferably about 85 μm or less, more preferably about 50 μm or less, still more preferably about 40 μm or less, particularly preferably about 35 μm or less. The thickness of the barrier layer 3 is preferably about 10 μm or more, more preferably about 20 μm or more, still more preferably about 25 μm or more. The total thickness of the barrier layer 3 is preferably in the range of about 10 to 85 μm, about 10 to 50 μm, about 10 to 40 μm, about 10 to 35 μm, about 20 to 85 μm, about 20 to 50 μm, about 20 to 40 μm, about 20 to 35 μm, about 25 to 85 μm, about 25 to 50 μm, about 25 to 40 μm, or about 25 to 35 μm. When the barrier layer 3 is formed of an aluminum alloy foil, the thickness thereof is especially preferably in above-described range. From the viewpoint of imparting high moldability and high rigidity to the exterior material 10 for electrical storage devices, the thickness of the barrier layer 3 is preferably about 35 μm or more, more preferably about 45 μm or more, still more preferably about 50 μm or more, still more preferably about 55 μm or more, and preferably about 200 μm or less, more preferably about 85 μm or less, still more preferably about 75 μm or less, still more preferably about 70 μm or less, and is preferably in the range of about 35 to 200 μm, about 35 to 85 μm, about 35 to 75 μm, about 35 to 70 μm, about 45 to 200 μm, about 45 to 85 μm, about 45 to 75 μm, about 45 to 70 μm, about 50 to 200 μm, about 50 to 85 μm, about 50 to 75 μm, about 50 to 70 μm, about 55 to 200 μm, about 55 to 85 μm, about 55 to 75 μm, or about 55 to 70 μm. When the exterior material 10 for electrical storage devices has high moldability, deep drawing molding can be facilitated to contribute to an increase in capacity of the electrical storage device. When the capacity of the electrical storage device is increased, the weight of the electrical storage device increases, but the enhancement of the rigidity of the exterior material 10 for electrical storage devices can contribute to high hermeticity of the electrical storage device. In particular, when the barrier layer 3 includes a stainless steel foil, the thickness of the stainless steel foil is preferably about 60 μm or less, more preferably about 50 μm or less, still more preferably about 40 μm or less, even more preferably about 30 μm or less, particularly preferably about 25 μm or less. The thickness of the stainless steel foil is preferably about 10 μm or more, more preferably about 15 μm or more. The thickness of the stainless steel foil is preferably in the range of about 10 to 60 μm, about 10 to 50 μm, about 10 to 40 μm, about 10 to 30 μm, about 10 to 25 μm, about 15 to 60 μm, about 15 to 50 μm, about 15 to 40 μm, about 15 to 30 μm, or about 15 to 25 μm.

When the barrier layer 3 is a metal foil, it is preferable that a corrosion-resistant film is provided at least on a surface on a side opposite to the base material layer for preventing dissolution and corrosion. The barrier layer 3 may include a corrosion-resistant film on each of both surfaces. Here, the corrosion-resistant film refers to a thin film obtained by subjecting the surface of the barrier layer to, for example, hydrothermal denaturation treatment such as boehmite treatment, chemical conversion treatment, anodization treatment, plating treatment with nickel, chromium or the like, or corrosion prevention treatment by applying a coating agent to impart corrosion resistance (e.g. acid resistance and alkali resistance) to the barrier layer. Specifically, the corrosion-resistant film means a film which improves the acid resistance of the barrier layer (acid-resistant film), a film which improves the alkali resistance of the barrier layer (alkali-resistant film), or the like. One of treatments for forming the corrosion-resistant film may be performed, or two or more thereof may be performed in combination. In addition, not only one layer but also multiple layers can be formed. Further, of these treatments, the hydrothermal denaturation treatment and the anodization treatment are treatments in which the surface of the metal foil is dissolved with a treatment agent to form a metal compound excellent in corrosion resistance. The definition of the chemical conversion treatment may include these treatments. When the barrier layer 3 is provided with the corrosion-resistant film, the barrier layer 3 is regarded as including the corrosion-resistant film.

The corrosion-resistant film exhibits the effects of preventing delamination between the barrier layer (e.g. an aluminum alloy foil) and the base material layer during molding of the exterior material for electrical storage devices; preventing dissolution and corrosion of the surface of the barrier layer, particularly dissolution and corrosion of aluminum oxide present on the surface of the barrier layer when the barrier layer is an aluminum alloy foil, by hydrogen fluoride generated by reaction of an electrolyte with moisture; improving the bondability (wettability) of the surface of the barrier layer; preventing delamination between the base material layer and the barrier layer during heat-sealing; and preventing delamination between the base material layer and the barrier layer during molding.

Various corrosion-resistant films formed by chemical conversion treatment are known, and examples thereof include mainly corrosion-resistant films containing at least one of a phosphate, a chromate, a fluoride, a triazine thiol compound, and a rare earth oxide. Examples of the chemical conversion treatment using a phosphate or a chromate include chromic acid chromate treatment, phosphoric acid chromate treatment, phosphoric acid-chromate treatment and chromate treatment, and examples of the chromium compound used in these treatments include chromium nitrate, chromium fluoride, chromium sulfate, chromium acetate, chromium oxalate, chromium biphosphate, acetylacetate chromate, chromium chloride and chromium potassium sulfate. Examples of the phosphorus compound used in these treatments include sodium phosphate, potassium phosphate, ammonium phosphate and polyphosphoric acid. Examples of the chromate treatment include etching chromate treatment, electrolytic chromate treatment and coating-type chromate treatment, and coating-type chromate treatment is preferable. This coating-type chromate treatment is treatment in which at least a surface of the barrier layer (e.g. an aluminum alloy foil) on the inner layer side is first degreased by a well-known treatment method such as an alkali immersion method, an electrolytic cleaning method, an acid cleaning method, an electrolytic acid cleaning method or an acid activation method, and a treatment solution containing a metal phosphate such as Cr (chromium) phosphate, Ti (titanium) phosphate, Zr (zirconium) phosphate or Zn (zinc) phosphate or a mixture of these metal salts as a main component, a treatment solution containing any of non-metal salts of phosphoric acid and a mixture of these non-metal salts as a main component, or a treatment solution formed of a mixture of any of these salts and a synthetic resin or the like is then applied to the degreased surface by a well-known coating method such as a roll coating method, a gravure printing method or an immersion method, and dried. As the treatment liquid, for example, various solvents such as water, an alcohol-based solvent, a hydrocarbon-based solvent, a ketone-based solvent, an ester-based solvent, and an ether-based solvent can be used, and water is preferable. Examples of the resin component used here include polymers such as phenol-based resins and acryl-based resins, and examples of the treatment include chromate treatment using an aminated phenol polymer having any of repeating units represented by the following general formulae (1) to (4). In the aminated phenol polymer, the repeating units represented by the following general formulae (1) to (4) may be contained alone, or may be contained in combination of two or more thereof. The acryl-based resin is preferably polyacrylic acid, an acrylic acid-methacrylic acid ester copolymer, an acrylic acid-maleic acid copolymer, an acrylic acid-styrene copolymer, or a derivative thereof such as a sodium salt, an ammonium salt or an amine salt thereof. In particular, a derivative of polyacrylic acid such as an ammonium salt, a sodium salt or an amine salt of polyacrylic acid is preferable. In the present disclosure, the polyacrylic acid means a polymer of acrylic acid. The acryl-based resin is also preferably a copolymer of acrylic acid and dicarboxylic acid or dicarboxylic anhydride, and is also preferably an ammonium salt, a sodium salt or an amine salt of a copolymer of acrylic acid and dicarboxylic acid or dicarboxylic anhydride. The acryl-based resins may be used alone, or may be used in combination of two or more thereof.

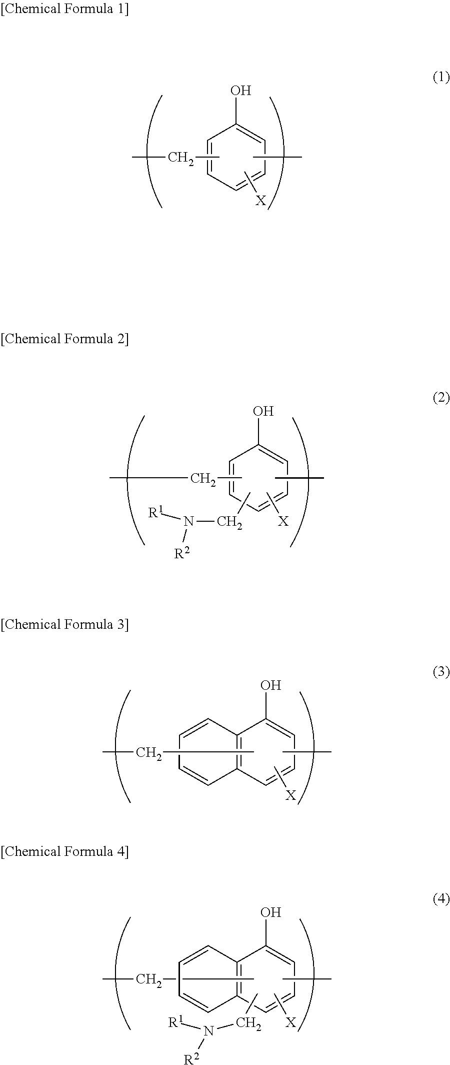

In the general formulae (1) to (4), X represents a hydrogen atom, a hydroxy group, an alkyl group, a hydroxyalkyl group, an allyl group, or a benzyl group. R¹ and R² are the same or different, and each represents a hydroxy group, an alkyl group, or a hydroxyalkyl group. In the general formulae (1) to (4), examples of the alkyl group represented by X, R¹ and R² include linear or branched alkyl groups with a carbon number of 1 to 4, such as a methyl group, an ethyl group, an n-propyl group, an isopropyl group, an n-butyl group, an isobutyl group, and a tert-butyl group. Examples of the hydroxyalkyl group represented by X, R¹ and R² include linear or branched alkyl groups with a carbon number of 1 to 4, which is substituted with one hydroxy group, such as a hydroxymethyl group, a 1-hydroxyethyl group, a 2-hydroxyethyl group, a 1-hydroxypropyl group, a 2-hydroxypropyl group, a 3-hydroxypropyl group, a 1-hydroxybutyl group, a 2-hydroxybutyl group, a 3-hydroxybutyl group, and a 4-hydroxybutyl group. In the general formulae (1) to (4), the alkyl group and the hydroxyalkyl group represented by X, R¹ and R² may be the same or different. In the general formulae (1) to (4), X is preferably a hydrogen atom, a hydroxy group or a hydroxyalkyl group. A number average molecular weight of the aminated phenol polymer having repeating units represented by the general formulae (1) to (4) is preferably about 500 to 1,000,000, and more preferably about 1,000 to 20,000, for example. The aminated phenol polymer is manufactured by, for example, performing polycondensation of a phenol compound or a naphthol compound with formaldehyde to prepare a polymer including repeating units represented by the general formula (1) or the general formula (3), and then introducing a functional group (—CH₂NR¹R²) into the obtained polymer using formaldehyde and an amine (R¹R²NH). The aminated phenol polymers are used alone, or used in combination of two or more thereof.

Other examples of the corrosion-resistant film include thin films formed by corrosion prevention treatment of coating type in which a coating agent containing at least one selected from the group consisting of a rare earth element oxide sol, an anionic polymer and a cationic polymer is applied. The coating agent may further contain phosphoric acid or a phosphate, and a crosslinker for crosslinking the polymer. In the rare earth element oxide sol, fine particles of a rare earth element oxide (e.g. particles having an average particle diameter of 100 nm or less) are dispersed in a liquid dispersion medium. Examples of the rare earth element oxide include cerium oxide, yttrium oxide, neodymium oxide and lanthanum oxide, and cerium oxide is preferable from the viewpoint of further improving adhesion. The rare earth element oxides contained in the corrosion-resistant film can be used alone, or used in combination of two or more thereof. As the liquid dispersion medium for the rare earth element oxide, for example, various solvents such as water, an alcohol-based solvent, a hydrocarbon-based solvent, a ketone-based solvent, an ester-based solvent, and an ether-based solvent can be used, and water is preferable. For example, the cationic polymer is preferably polyethyleneimine, an ion polymer complex formed of a polymer having polyethyleneimine and a carboxylic acid, primary amine-grafted acrylic resins obtained by graft-polymerizing a primary amine with an acrylic main backbone, polyallylamine or a derivative thereof, or aminated phenol. The anionic polymer is preferably poly (meth)acrylic acid or a salt thereof, or a copolymer containing (meth)acrylic acid or a salt thereof as a main component. The crosslinker is preferably at least one selected from the group consisting of a silane coupling agent and a compound having any of functional groups including an isocyanate group, a glycidyl group, a carboxyl group and an oxazoline group. In addition, the phosphoric acid or phosphate is preferably condensed phosphoric acid or a condensed phosphate.

Examples of the corrosion-resistant film include films formed by applying a dispersion of fine particles of a metal oxide such as aluminum oxide, titanium oxide, cerium oxide or tin oxide or barium sulfate in phosphoric acid to the surface of the barrier layer and performing baking treatment at 150° C. or higher.

The corrosion-resistant film may have a laminated structure in which at least one of a cationic polymer and an anionic polymer is further laminated if necessary. Examples of the cationic polymer and the anionic polymer include those described above.

The composition of the corrosion-resistant film can be analyzed by, for example, time-of-flight secondary ion mass spectrometry.

The amount of the corrosion-resistant film to be formed on the surface of the barrier layer 3 in the chemical conversion treatment is not particularly limited, but for example when the coating-type chromate treatment is performed, and it is desirable that the chromic acid compound be contained in an amount of, for example, about 0.5 to 50 mg, preferably about 1.0 to 40 mg, in terms of chromium, the phosphorus compound be contained in an amount of, for example, about 0.5 to 50 mg, preferably about 1.0 to 40 mg, in terms of phosphorus, and the aminated phenol polymer be contained in an amount of, for example, about 1.0 to 200 mg, preferably about 5.0 to 150 mg, per 1 m² of the surface of the barrier layer 3.

The thickness of the corrosion-resistant film is not particularly limited, and is preferably about 1 nm to 20 μm, more preferably about 1 nm to 100 nm, still more preferably about 1 nm to 50 nm from the viewpoint of the cohesive force of the film and the adhesive strength with the barrier layer and the heat-sealable resin layer. The thickness of the corrosion-resistant film can be measured by observation with a transmission electron microscope or a combination of observation with a transmission electron microscope and energy dispersive X-ray spectroscopy or electron beam energy loss spectroscopy. By analyzing the composition of the corrosion-resistant film using time-of-flight secondary ion mass spectrometry, peaks derived from secondary ions from, for example, Ce, P and O (e.g. at least one of Ce₂PO₄⁺, CePO₄⁻ and the like) and secondary ions from, for example, Cr, P and O (e.g. at least one of CrPO₂⁺, CrPO₄⁻ and the like) are detected.

The chemical conversion treatment is performed in the following manner: a solution containing a compound to be used for formation of a corrosion-resistant film is applied to the surface of the barrier layer by a bar coating method, a roll coating method, a gravure coating method, an immersion method or the like, and heating is then performed so that the temperature of the barrier layer is about 70 to about 200° C. The barrier layer may be subjected to a degreasing treatment by an alkali immersion method, an electrolytic cleaning method, an acid cleaning method, an electrolytic acid cleaning method or the like before the barrier layer is subjected to a chemical conversion treatment. When a degreasing treatment is performed as described above, the chemical conversion treatment of the surface of the barrier layer can be further efficiently performed. When an acid degreasing agent with a fluorine-containing compound dissolved in an inorganic acid is used for degreasing treatment, not only a metal foil degreasing effect can be obtained but also a metal fluoride can be formed as a passive state, and in this case, only degreasing treatment may be performed.

### [Heat-Sealable Resin Layer 4]

In the exterior material for electrical storage devices according to the present disclosure, the heat-sealable resin layer 4 is a layer (sealant layer) which corresponds to an innermost layer and performs a function of hermetically sealing the electrical storage device element by heat-sealing the heat-sealable resin layer during construction of the electrical storage device.

The resin forming the heat-sealable resin layer 4 is not particularly limited as long as it can be heat-sealed, a resin containing a polyolefin backbone such as a polyolefin or an acid-modified polyolefin is preferable. The resin forming the heat-sealable resin layer 4 can be confirmed to contain a polyolefin backbone by an analysis method such as infrared spectroscopy or gas chromatography-mass spectrometry. It is preferable that a peak derived from maleic anhydride is detected when the resin forming the heat-sealable resin layer 4 is analyzed by infrared spectroscopy. For example, when a maleic anhydride-modified polyolefin is measured by infrared spectroscopy, peaks derived from maleic anhydride are detected near wavenumbers of 1760 cm-1 and 1780 cm-1. When the heat-sealable resin layer 4 is a layer formed of a maleic anhydride-modified polyolefin, a peak derived from maleic anhydride is detected when measurement is performed by infrared spectroscopy. However, if the degree of acid modification is low, the peaks may be too small to be detected. In that case, the peaks can be analyzed by nuclear magnetic resonance spectroscopy.

The heat-sealable resin layer 4 preferably contains a resin containing a polyolefin backbone as a main component, more preferably contains polyolefin as a main component, still more preferably contains polypropylene as a main component. Here, the main component means a resin component, the content ratio of which is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the heat-sealable resin layer 4. For example, the phrase “the heat-sealable resin layer 4 contains polypropylene as a main component” means that the content ratio of polypropylene is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the heat-sealable resin layer 4.

Specific examples of the polyolefin include polyethylenes such as low-density polyethylene, medium-density polyethylene, high-density polyethylene and linear low-density polyethylene; ethylene-α-olefin copolymers; polypropylene such as homopolypropylene, block copolymers of polypropylene (e.g., block copolymers of propylene and ethylene) and random copolymers of polypropylene (e.g., random copolymers of propylene and ethylene); propylene-α-olefin copolymers; and terpolymers of ethylene-butene-propylene. Of these, polypropylene is preferable. The polyolefin resin in the case of a copolymer may be a block copolymer or a random copolymer. These polyolefin-based resins may be used alone, or may be used in combination of two or more thereof.

The polyolefin may be a cyclic polyolefin. The cyclic polyolefin is a copolymer of an olefin and a cyclic monomer, and examples of the olefin as a constituent monomer of the cyclic polyolefin include ethylene, propylene, 4-methyl-1-pentene, styrene, butadiene and isoprene. Examples of the cyclic monomer as a constituent monomer of the cyclic polyolefin include cyclic alkenes such as norbornene; cyclic dienes such as cyclopentadiene, dicyclopentadiene, cyclohexadiene and norbornadiene. Among these polyolefins, cyclic alkenes are preferable, and norbornene is more preferable.

The polyolefin may be an acid-modified polyolefin. The acid-modified polyolefin is a polymer with the polyolefin modified by subjecting the polyolefin to block polymerization or graft polymerization with an acid component. As the polyolefin to be acid-modified, the above-mentioned polyolefins, copolymers obtained by copolymerizing polar molecules such as acrylic acid or methacrylic acid with the above-mentioned polyolefins, polymers such as crosslinked polyolefins, or the like can also be used. Examples of the acid component to be used for acid modification include carboxylic acids such as maleic acid, acrylic acid, itaconic acid, crotonic acid, maleic anhydride and itaconic anhydride, and anhydrides thereof.

The acid-modified polyolefin may be an acid-modified cyclic polyolefin. The acid-modified cyclic polyolefin is a polymer obtained by copolymerizing a part of monomers forming the cyclic polyolefin in place of an acid component, or block-polymerizing or graft-polymerizing an acid component with the cyclic polyolefin. The cyclic polyolefin to be modified with an acid is the same as described above. The acid component to be used for acid modification is the same as the acid component used for modification of the polyolefin.

Examples of preferred acid-modified polyolefins include polyolefins modified with a carboxylic acid or an anhydride thereof, polypropylene modified with a carboxylic acid or an anhydride thereof, maleic anhydride-modified polyolefins, and maleic anhydride-modified polypropylene.

The heat-sealable resin layer 4 may be formed from one resin alone, or may be formed from a blend polymer obtained by combining two or more resins. Further, the heat-sealable resin layer 4 may be composed of only one layer, or may be composed of two or more layers with the same resin component or different resin components.

The heat-sealable resin layer 4 may contain a slipping agent etc. if necessary. When the heat-sealable resin layer 4 contains a slipping agent, the moldability of the exterior material for electrical storage devices can be improved. The slipping agent is not particularly limited, and a known slipping agent can be used.

The slipping agent is not particularly limited, and is preferably an amide-based slipping agent. Specific examples of the slipping agent include those exemplified for the base material layer 1. The slipping agents may be used alone, or may be used in combination of two or more thereof, and are preferably used in combination of two or more thereof.

In the present disclosure, it is preferable that a slipping agent is present on the surface of the heat-sealable resin layer 4 and/or inside the heat-sealable resin layer 4 from the viewpoint of enhancing the moldability of the exterior material for electrical storage devices. The slipping agent is not particularly limited, and is preferably an amide-based slipping agent. Specific examples of the amide-based slipping agent include saturated fatty acid amides, unsaturated fatty acid amides, substituted amides, methylol amides, saturated fatty acid bisamides, unsaturated fatty acid bisamides, fatty acid ester amides, and aromatic bisamides. Specific examples of the saturated fatty acid amide include lauric acid amide, palmitic acid amide, stearic acid amide, behenic acid amide, and hydroxystearic acid amide. Specific examples of unsaturated fatty acid amide include oleic acid amide and erucic acid amide. Specific examples of the substituted amide include N-oleylpalmitic acid amide, N-stearyl stearic acid amide, N-stearyl oleic acid amide, N-oleyl stearic acid amide, and N-stearyl erucic acid amide.

Specific examples of the methylolamide include methylolstearic acid amide. Specific examples of the saturated fatty acid bisamide include methylenebisstearic acid amide, ethylenebiscapric acid amide, ethylenebislauric acid amide, ethylenebisstearic acid amide, ethylenebishydroxystearic acid amide, ethylenebisbehenic acid amide, hexamethylenebisstearic acid amide, hexamethylenehydroxystearic acid amide, N,N′-distearyl adipic acid amide, and N,N′-distearyl sebacic acid amide. Specific examples of the unsaturated fatty acid bisamide include ethylenebisoleic acid amide, ethylenebiserucic acid amide, hexamethylenebisoleic acid amide, N,N′-dioleyladipic acid amide, and N,N′-dioleylsebacic acid amide. Specific examples of the fatty acid ester amide include stearoamideethyl stearate. Specific examples of the aromatic bisamide include m-xylylenebisstearic acid amide, m-xylylenebishydroxystearic acid amide, and N,N′-distearylisophthalic acid amide. The slipping agents may be used alone, or may be used in combination of two or more thereof, and are preferably used in combination of two or more thereof.

When the slipping agent is present on the surface of the heat-sealable resin layer 4, the amount of the slipping agent present is not particularly limited. From the viewpoint of improving the moldability of the exterior material for electrical storage devices, the amount of the slipping agent present is preferably about 1 mg/m2 or more, more preferably about 3 mg/m2 or more, still more preferably about 5 mg/m2 or more, still more preferably about 10 mg/m2 or more, still more preferably about 15 mg/m2 or more, and preferably about 50 mg/m2 or less, more preferably about 40 mg/m2 or less, and is preferably in the range of 1 to 50 mg/m2, about 1 to 40 mg/m2, about 3 to 50 mg/m2, about 3 to 40 mg/m2, about 5 to 50 mg/m2, about 5 to 40 mg/m2, about 10 to 50 mg/m2, about 10 to 40 mg/m2, about 15 to 50 mg/m2, or about 15 to 40 mg/m².

When the slipping agent is present inside the heat-sealable resin layer 4, the amount of the slipping agent present is not particularly limited. From the viewpoint of improving the moldability of the exterior material for electrical storage devices, the amount of the slipping agent present is preferably about 100 ppm or more, more preferably about 300 ppm or more, still more preferably about 500 ppm or more, and preferably about 3,000 ppm or less, more preferably about 2,000 ppm or less, and is preferably in the range of about 100 to 3,000 ppm, about 100 to 2,000 ppm, about 300 to 3,000 ppm, about 300 to 2,000 ppm, about 500 to 3,000 ppm, or about 500 to 2,000 ppm. When two or more slipping agents are present inside the heat-sealable resin layer 4, the above-described slipping agent amount is the total amount of the slipping agents. In addition, when two or more types of slipping agents are present inside the heat-sealable resin layer 4, the amount of the first type of slipping agent present is not particularly limited. From the viewpoint of improving the moldability of the exterior material for electrical storage devices, the amount of the first type of slipping agent present is preferably about 100 ppm or more, more preferably about 300 ppm or more, still more preferably about 500 ppm or more, and preferably about 3,000 ppm or less, more preferably about 2,000 ppm or less, and is preferably in the range of about 100 to 3,000 ppm, about 100 to 2,000 ppm, about 300 to 3,000 ppm, about 300 to 2,000 ppm, about 500 to 3,000 ppm, or about 500 to 2,000 ppm. The amount of the second type of slipping agent present is not particularly limited. From the viewpoint of improving the moldability of the exterior material for electrical storage devices, the amount of the slipping agent present is preferably about 50 ppm or more, more preferably about 100 ppm or more, still more preferably about 200 ppm or more, and preferably about 1,500 ppm or less, more preferably about 1,000 ppm or less, and is preferably in the range of about 50 to 1,500 ppm, about 50 to 1,000 ppm, about 100 to 1,500 ppm, about 100 to 1,000 ppm, about 200 to 1,500 ppm, or about 200 to 1,000 ppm.

The slipping agent present on the surface of the heat-sealable resin layer 4 may be one obtained by exuding the slipping agent contained in the resin forming the heat-sealable resin layer 4, or one obtained by applying a slipping agent to the surface of the heat-sealable resin layer 4.

The thickness of the heat-sealable resin layer 4 is not particularly limited as long as the heat-sealable resin layers are heat-sealed to each other to perform a function of sealing the electrical storage device element, and the thickness is, for example, about 100 μm or less, preferably about 85 μm or less, more preferably about 15 to 85 μm. For example, when the thickness of the adhesive layer 5 described later is 10 μm or more, the thickness of the heat-sealable resin layer 4 is preferably about 85 μm or less, more preferably about 15 to 45 μm. For example, when the thickness of the adhesive layer 5 described later is less than 10 μm or the adhesive layer 5 is not provided, the thickness of the heat-sealable resin layer 4 is preferably about 20 μm or more, more preferably about 35 to 85 μm.

### [Adhesive Layer 5]

In the exterior material for electrical storage devices according to the present disclosure, the adhesive layer 5 is a layer provided between the barrier layer 3 (or corrosion-resistant film) and the heat-sealable resin layer 4 if necessary for firmly bonding these layers to each other.

The adhesive layer 5 is formed from a resin capable of bonding the barrier layer 3 and the heat-sealable resin layer 4 to each other. The resin to be used for forming the adhesive layer 5 is, for example, the same as that of the adhesive exemplified for the adhesive agent layer 2. From the viewpoint of firmly bonding the adhesive layer 5 to the heat-sealable resin layer 4, it is preferable that the resin to be used for forming the adhesive layer 5 contains a polyolefin backbone. Examples thereof include the polyolefins, acid-modified polyolefins, cyclic polyolefins and acid-modified cyclic polyolefins exemplified for the heat-sealable resin layer 4 described above. On the other hand, from the viewpoint of firmly bonding the barrier layer 3 and the adhesive layer 5 to each other, it is preferable that the adhesive layer 5 contains an acid-modified polyolefin. Examples of the acid modifying component include dicarboxylic acids such as maleic acid, itaconic acid, succinic acid and adipic acid, anhydrides thereof, acrylic acid, and methacrylic acid, and maleic anhydride is most preferable from the viewpoint of ease of modification, general-purpose property, and the like. From the viewpoint of the heat resistance of the exterior material for electrical storage devices, the olefin component is preferably a polypropylene-based resin, and it is most preferable that the adhesive layer 5 contains maleic anhydride-modified polypropylene.

When a resin containing a polyolefin backbone is used for formation of the adhesive layer 5, the adhesive layer 5 preferably contains a resin containing a polyolefin backbone as a main component, more preferably contains acid-modified polyolefin as a main component, still more preferably contains acid-modified polypropylene as a main component. Here, the main component means a resin component, the content ratio of which is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the adhesive layer 5. For example, the phrase “the adhesive layer 5 contains acid-modified polypropylene as a main component” means that the content ratio of acid-modified polypropylene is, for example, 50 mass % or more, preferably 60 mass % or more, more preferably 70 mass % or more, still more preferably 80 mass % or more, still more preferably 90 mass % or more, still more preferably 95 mass % or more, still more preferably 98 mass % or more, still more preferably 99 mass % or more with respect to resin components contained in the adhesive layer 5.

The resin forming the adhesive layer 5 can be confirmed to contain a polyolefin backbone by an analysis method such as infrared spectroscopy, gas chromatography-mass spectrometry, and the analysis method is not particularly limited. The resin forming the adhesive layer 5 is confirmed to contain an acid-modified polyolefin, for example, when peaks derived from maleic anhydride are detected near wavenumbers of 1760 cm⁻¹ and 1780 cm⁻¹ when a maleic anhydride-modified polyolefin is measured by infrared spectroscopy. However, if the degree of acid modification is low, the peaks may be too small to be detected. In that case, the peaks can be analyzed by nuclear magnetic resonance spectroscopy.

Further, from the viewpoint of securing durability, such as heat resistance and content resistance and securing moldability, of the exterior material for electrical storage devices while reducing the thickness, the adhesive layer 5 is more preferably a cured product of a resin composition containing an acid-modified polyolefin and a curing agent. Preferred examples of the acid-modified polyolefin include those described above.

The adhesive layer 5 is preferably a cured product of a resin composition containing an acid-modified polyolefin and at least one selected from the group consisting of a compound having an isocyanate group, a compound having an oxazoline group, and a compound having an epoxy group, especially preferably a cured product of a resin composition containing an acid-modified polyolefin and at least one selected from the group consisting of a compound having an isocyanate group and a compound having an epoxy group. Preferably, the adhesive layer 5 preferably contains at least one selected from the group consisting of polyurethane, polyester and epoxy resin. More preferably, the adhesive layer 5 contains polyurethane and epoxy resin. As the polyester, for example, an ester resin produced by reaction of an epoxy group with a maleic anhydride group, or an amide ester resin produced by reaction of an oxazoline group with a maleic anhydride group is preferable. When an unreacted substance of a curing agent, such as a compound having an isocyanate group, a compound having an oxazoline group, or an epoxy resin remains in the adhesive layer 5, the presence of the unreacted substance can be confirmed by, for example, a method selected from infrared spectroscopy, Raman spectroscopy, time-of-flight secondary ion mass spectrometry (TOF-SIMS) and the like.

From the viewpoint of further improving adhesion between the barrier layer 3 and the adhesive layer 5, the adhesive layer 5 is preferably a cured product of a resin composition containing a curing agent having at least one selected from the group consisting of an oxygen atom, a heterocyclic ring, a C═N bond, and a C—O—C bond. Examples of the curing agent having a heterocyclic ring include curing agents having an oxazoline group, and curing agents having an epoxy group. Examples of the curing agent having a C═N bond include curing agents having an oxazoline group and curing agents having an isocyanate group. Examples of the curing agent having a C—O—C bond include curing agents having an oxazoline group, curing agents having an epoxy group. Whether the adhesive layer 5 is a cured product of a resin composition containing any of these curing agents can be confirmed by, for example, a method such as gas chromatography-mass spectrometry (GCMS), infrared spectroscopy (IR), time-of-flight secondary ion mass spectrometry (TOF-SIMS), or X-ray photoelectron spectroscopy (XPS).

The compound having an isocyanate group is not particularly limited, and is preferably a polyfunctional isocyanate compound from the viewpoint of effectively improving adhesion between the barrier layer 3 and the adhesive layer 5. The polyfunctional isocyanate compound is not particularly limited as long as it is a compound having two or more isocyanate groups. Specific examples of the polyfunctional isocyanate-based curing agent include pentane diisocyanate (PDI), isophorone diisocyanate (IPDI), hexamethylene diisocyanate (HDI), tolylene diisocyanate (TDI), diphenylmethane diisocyanate (MDI), polymerized or nurated products thereof, mixtures thereof, and copolymers of these compounds with other polymers. Examples thereof include adduct forms, biuret forms, and isocyanurate forms.

The content of the compound having an isocyanate group in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

The compound having an oxazoline group is not particularly limited as long as it is a compound having an oxazoline backbone. Specific examples of the compound having an oxazoline group include compounds having a polystyrene main chain and compounds having an acrylic main chain. Examples of the commercially available product include EPOCROS series manufactured by Nippon Shokubai Co., Ltd.

The proportion of the compound having an oxazoline group in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

Examples of the compound having an epoxy group include epoxy resins. The epoxy resin is not particularly limited as long as it is a resin capable of forming a crosslinked structure by epoxy groups existing in the molecule, and a known epoxy resin can be used. The weight average molecular weight of the epoxy resin is preferably about 50 to 2,000, more preferably about 100 to 1,000, still more preferably about 200 to 800. In the first present disclosure, the weight average molecular weight of the epoxy resin is a value obtained by performing measurement by gel permeation chromatography (GPC) under the condition of using polystyrene as a standard sample.

Specific examples of the epoxy resin include glycidyl ether derivatives of trimethylolpropane, bisphenol A diglycidyl ether, modified bisphenol A diglycidyl ether, bisphenol F-type glycidyl ether, novolak glycidyl ether, glycerin polyglycidyl ether and polyglycerin polyglycidyl ether. The epoxy resins may be used alone, or may be used in combination of two or more thereof.

The proportion of the epoxy resin in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5.

The polyurethane is not particularly limited, and a known polyurethane can be used. The adhesive layer 5 may be, for example, a cured product of two-liquid curable polyurethane.

The proportion of the polyurethane in the adhesive layer 5 is preferably in the range of 0.1 to 50 mass %, more preferably in the range of 0.5 to 40 mass % in the resin composition forming the adhesive layer 5. This enables effective improvement of adhesion between the barrier layer 3 and the adhesive layer 5 in an atmosphere including a component which induces corrosion of the barrier layer, such as an electrolytic solution.

When the adhesive layer 5 is a cured product of a resin composition containing at least one selected from the group consisting of a compound having an isocyanate group, a compound having an oxazoline group and an epoxy resin, and the acid-modified polyolefin, the acid-modified polyolefin functions as a main component, and the compound having an isocyanate group, the compound having an oxazoline group, and the compound having an epoxy group each function as a curing agent.

The adhesive layer 5 may contain a modifier having a carbodiimide group.

In manufacturing of the exterior material 10 for electrical storage devices according to the present disclosure by laminating the adhesive layer 5 with the barrier layer 3, the heat-sealable resin layer 4 or the like, a resin film formed in advance may be used as the adhesive layer 5. A heat-sealable resin for forming the adhesive layer 5 may be formed into a film on the surface of the barrier layer 3, the heat-sealable resin layer 4 or the like by extrusion molding, coating or the like to obtain the adhesive layer 5 formed of a resin film.

The thickness of the adhesive layer 5 is preferably about 50 μm or less, about 40 μm or less, about 30 μm or less, about 20 μm or less, or about 5 μm or less. The thickness of the adhesive layer 5 is preferably about 0.1 μm or more, or about 0.5 μm or more. The thickness of the adhesive layer 5 is preferably in the range of about 0.1 to 50 μm, about 0.1 to 40 μm, about 0.1 to 30 μm, about 0.1 to 20 μm, about 0.1 to 5 μm, about 0.5 to 50 μm, about 0.5 to 40 μm, about 0.5 to 30 μm, about 0.5 to 20 μm, or about 0.5 to 5 μm. More specifically, the thickness is preferably about 1 to 10 μm, more preferably about 1 to 5 μm in the case of the adhesive exemplified for the adhesive agent layer 2 or a cured product of an acid-modified polyolefin with a curing agent. When any of the resins exemplified for the heat-sealable resin layer 4 is used, the thickness of the adhesive layer is preferably about 2 to 50 μm, more preferably about 10 to 40 μm. When the adhesive layer 5 is a cured product of a resin composition containing the adhesive exemplified for the adhesive agent layer 2 or an acid-modified polyolefin and a curing agent, the adhesive layer 5 can be formed by, for example, applying the resin composition and curing the resin composition by heating or the like. When the resin exemplified for the heat-sealable resin layer 4 is used, for example, extrusion molding of the heat-sealable resin layer 4 and the adhesive layer 5 can be performed.

### 3. Method for Manufacturing Exterior Material for Electrical Storage Devices

The method for manufacturing an exterior material for electrical storage devices is not particularly limited as long as a laminate is obtained in which the layers of the exterior material for electrical storage devices according to the present disclosure are laminated. Examples thereof include a method including the step of laminating at least the surface coating layer 6, the base material layer 1, the barrier layer 3 and the heat-sealable resin layer 4 in this order. In the method for manufacturing an exterior material for electrical storage devices according to the present disclosure, the surface coating layer 6 contains a resin and a filler, and when a reflectance of the outer surface of the surface coating layer 6 is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less.

An example of the method for manufacturing the exterior material for electrical storage devices of the present disclosure is as follows. First, a laminate including the base material layer 1, the adhesive agent layer 2 and the barrier layer 3 in this order (hereinafter, the laminate may be described as a “laminate A”) is formed. Specifically, the laminate A can be formed by a dry lamination method in which an adhesive to be used for formation of the adhesive agent layer 2 is applied onto the base material layer 1 or the barrier layer 3, the surface of which is subjected to a chemical conversion treatment if necessary, using a coating method such as a gravure coating method or a roll coating method, and dried, the barrier layer 3 or the base material layer 1 is then laminated, and the adhesive agent layer 2 is cured.

Then, the heat-sealable resin layer 4 is laminated on the barrier layer 3 of the laminate A. When the heat-sealable resin layer 4 is laminated directly on the barrier layer 3, the heat-sealable resin layer 4 may be laminated onto the barrier layer 3 of the laminate A by a method such as a thermal lamination method or an extrusion lamination method. When the adhesive layer 5 is provided between the barrier layer 3 and the heat-sealable resin layer 4, mention is made of, for example, (1) a method in which the adhesive layer 5 and the heat-sealable resin layer 4 are extruded to be laminated on the barrier layer 3 of the laminate A (extrusion lamination method or tandem lamination method); (2) a method in which the adhesive layer 5 and the heat-sealable resin layer 4 are laminated to form a laminate separately, and the laminate is laminated on the barrier layer 3 of the laminate A by a thermal lamination method, or a method in which a laminate with the adhesive layer 5 laminated on the barrier layer 3 of the laminate A is formed, and laminated to the heat-sealable resin layer 4 by a thermal lamination method; (3) a method in which the melted adhesive layer 5 is poured between the barrier layer 3 of the laminate A and the heat-sealable resin layer 4 formed in a sheet shape beforehand, and simultaneously the laminate A and the heat-sealable resin layer 4 are bonded to each other with the adhesive layer 5 interposed therebetween (sandwich lamination); and (4) an adhesive for forming the adhesive layer 5 is applied by solution coating and dried or baked to laminate the adhesive on the barrier layer 3 of the laminate A, and the heat-sealable resin layer 4 formed in a sheet shape in advance is laminated on the adhesive layer 5. That is, when the adhesive layer 5 is provided between the barrier layer 3 and the heat-sealable resin layer 4, the adhesive layer 5 and the heat-sealable resin layer 4 can be laminated by, for example, (1) an extrusion lamination method, (2) a thermal lamination method, (3) a sandwich lamination method, or (4) a dry lamination method. Examples of the (1) extrusion lamination method include a method in which the adhesive layer 5 and the heat-sealable resin layer 4 are extruded onto the barrier layer 3 of the laminate A to perform lamination (coextrusion lamination method or tandem lamination method). Examples of the (2) thermal lamination method include a method in which separately, a laminate in which the adhesive layer 5 and the heat-sealable resin layer 4 are laminated is formed, and laminated on the barrier layer 3 of the laminate A, and a method in which a laminate in which the adhesive layer 5 is laminated on the barrier layer 3 of the laminate A is formed, and laminated to the heat-sealable resin layer 4. Examples of the (3) sandwich lamination method include a method in which the laminate A and the heat-sealable resin layer 4 are bonded to each other with the adhesive layer 5 interposed therebetween while the melted adhesive layer 5 is poured between the barrier layer 3 of the laminate A and the heat-sealable resin layer 4 formed in a sheet shape in advance. Examples of the (4) dry lamination method include a method in which an adhesive for forming the adhesive layer 5 is laminated on the barrier layer 3 of the laminate A by, for example, a method in which the adhesive is applied by solution coating and dried, or a method in which the applied adhesive is further baked, and on the thus-obtained adhesive layer 5, the heat-sealable resin layer 4 formed in a sheet shape in advance is laminated.

The surface coating layer 6 is laminated on a surface of the base material layer 1 on a side opposite to the barrier layer 3. The surface coating layer 6 can be formed by, for example, coating a surface of the base material layer 1 with the resin that forms the surface coating layer 6. The order of the step of laminating the barrier layer 3 on a surface of the base material layer 1 and the step of laminating the surface coating layer 6 on a surface of the base material layer 1 is not particularly limited. For example, the surface coating layer 6 may be formed on a surface of the base material layer 1, followed by forming the barrier layer 3 on a surface of the base material layer 1 on a side opposite to the surface coating layer 6.

As described above, a laminate including the surface coating layer 6, the base material layer 1, the adhesive agent layer 2 provided if necessary, the barrier layer 3, the adhesive layer 5 provided if necessary, and the heat-sealable resin layer 4 in this order is formed, and the laminate may be further subjected to a heating treatment for strengthening the bondability of the adhesive agent layer 2 provided if necessary and the adhesive layer 5.

In the exterior material for electrical storage devices, the layers forming the laminate may be subjected to surface activation treatment such as corona treatment, blast treatment, oxidation treatment or ozone treatment if necessary to improve processing suitability. For example, by subjecting a surface of the base material layer 1, which is opposite to the barrier layer 3, to a corona treatment, the ink printability of the surface of the base material layer 1 can be improved.

### 4. Uses of Exterior Material for Electrical Storage Devices

The exterior material for electrical storage devices according to the present disclosure is used as a packaging for hermetically sealing and storing electrical storage device elements such as a positive electrode, a negative electrode, and an electrolyte. That is, in a packaging formed of the exterior material for electrical storage devices, an electrical storage device element including at least a positive electrode, a negative electrode, and an electrolyte can be stored to obtain an electrical storage device.

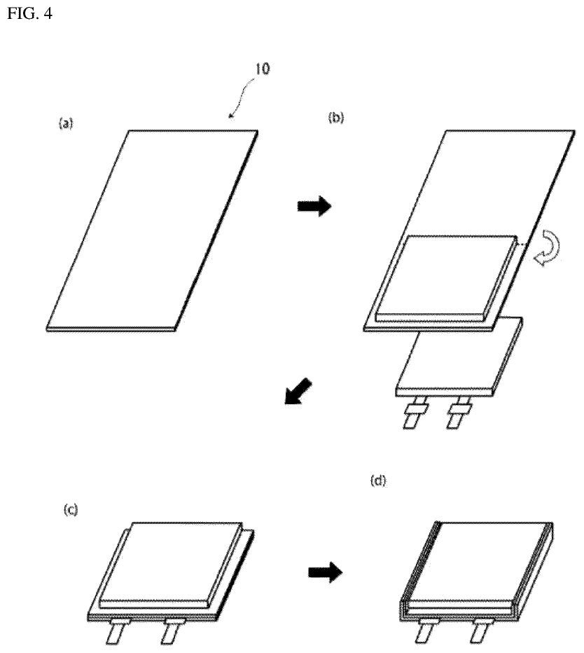

Specifically, an electrical storage device element including at least a positive electrode, a negative electrode, and an electrolyte is covered with the exterior material for electrical storage devices according to the present disclosure such that a flange portion (region where a heat-sealable resin layer is in contact with itself) can be formed on the periphery of the electrical storage device element while a metal terminal connected to each of the positive electrode and the negative electrode protrudes to the outside, and the heat-sealable resin layer at the flange portion is heat-sealed with itself, thereby providing an electrical storage device using the exterior material for electrical storage devices. When the electrical storage device element is stored in the packaging formed of the exterior material for electrical storage devices according to the present disclosure, the packaging is formed in such a manner that the heat-sealable resin portion of the exterior material for electrical storage devices according to the present disclosure is on the inner side (a surface contacting the electrical storage device element). The heat-sealable resin layers of two exterior materials for electrical storage devices may be superposed in such a manner as to face each other, followed by heat-sealing the peripheral edge portions of the superposed exterior materials for electrical storage devices to form a packaging. Alternatively, as in the example shown in FIG. 4, one exterior material for electrical storage devices may be folded over itself, followed by heat-sealing the peripheral edge portions to form a packaging. When the exterior material is folded over itself, a packaging may be formed by three-side sealing with the exterior material heat-sealed at sides other than the folding side as in the example shown in FIG. 4, or may be subjected to four-side sealing with the exterior material folded in such a manner that a flange portion can be formed, or a heat-sealed portion may be formed by winding the exterior material for electrical storage devices around the circumference of the electrical storage device element, and sealing the heat-sealable resin layers to each other, followed by disposition of a lid or the like to close the openings at both ends, which are heat-sealed to the exterior material for electrical storage devices wound around the periphery of the electrical storage device element, thereby being sealed. The lid can be formed by, for example, a resin molded article, a metal molded article or an exterior material for electrical storage devices. In the exterior material for electrical storage devices, a concave portion for housing an electrical storage device element may be formed by deep drawing molding or bulging molding. As in the example shown in FIG. 4, one exterior material for electrical storage devices may be provided with a concave portion while the other exterior material for electrical storage devices is not provided a concave portion, or the other exterior material for electrical storage devices may also be provided with a concave portion.

The exterior material for electrical storage devices according to the present disclosure can be suitably used for electrical storage devices such as batteries (including condensers, capacitors and the like.). The exterior material for electrical storage devices according to the present disclosure may be used for either primary batteries or secondary batteries, and is preferably used for secondary batteries. The type of secondary battery to which the exterior material for electrical storage devices according to the present disclosure is applied is not particularly limited, and examples thereof include lithium ion batteries, lithium ion polymer batteries, all-solid-state batteries, semi-solid-state batteries, pseudo-solid-state batteries, polymer batteries, all polymer batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers and capacitors. Of these secondary batteries, preferred subjects to which the exterior material for electrical storage devices according to the present disclosure is applied include lithium ion batteries and lithium ion polymer batteries.

### 5. Method for Inspecting Appearance of Exterior Material for Electrical Storage Devices

A method for inspecting an appearance of an exterior material for electrical storage devices according to the present disclosure can be used in a process of manufacturing an exterior material for electrical storage devices and a process of manufacturing an electrical storage device. In the method for inspecting an appearance of an exterior material for electrical storage devices according to the present disclosure, an exterior material for electrical storage devices whose appearance is to be inspected includes a laminate including at least a surface coating layer 6, a base material layer 1, a barrier layer 3 and a heat-sealable resin layer 4 in this order from the outside. In addition, the surface coating layer 6 contains a resin and a filler. Details of the laminated configuration and the layers of the exterior material for electrical storage devices are as described above.

The method for inspecting an appearance of an exterior material for electrical storage devices according to the present disclosure includes a step of preparing an exterior material for electrical storage devices whose appearance is to be inspected, and an inspection step of measuring a reflectance of an outer surface of the surface coating layer 6 by using a goniophotometer. The measurement of the reflectance using a goniophotometer enables quantitative evaluation of the reflectance of the outer surface of the exterior material for electrical storage devices at various angles. Thus, by measuring the reflectance using a goniophotometer, the matte-toned appearance in observation of the outer surface of the exterior material for electrical storage devices from various angles can be suitably inspected.

For example, for the outer surface of the exterior material for electrical storage devices, the intense of the reflectance in a predetermined angle range P including regular reflection of incident light from a predetermined angle, and the reflectance in an angle range Q different from the angle range P (for example, the reflectance of diffuse reflection) can be each measured to evaluate the characteristics of the outer surface of the exterior material for electrical storage devices. For example, the predetermined angle range P including regular reflection of incident light from a predetermined angle is set to a range of the angle of regular reflection±5° (for example, when the incident light angle of the goniophotometer is set to 60°, the angle of regular reflection is 60°, and the angle range P is a range of 55° or more and 65° or less). The intensity of the reflectance in the angle range P (a range of the angle of regular reflection)+5° is measured. The intensity of the reflectance in the angle range Q different from the angle range P (for example, a range of 70° or more and 80° or less) is also measured. The magnitude relationship and the ratio of maximum values of the reflectance in the angle range P and the angle range Q are calculated, whereby the reflectance at various angles can be quantitatively evaluated.

In addition, for example, for the outer surface of the exterior material for electrical storage devices, the intense of the reflectance in a predetermined angle range including regular reflection of incident light from a predetermined angle is measured to obtain a total value of reflectances at angles, which can be used to evaluate the reflectance of the outer surface of the exterior material for electrical storage devices at various angles.

Specific examples of the inspection step using an goniophotometer are shown below.

For example, a goniophotometer is used on the outer surface of the surface coating layer 6, and the incident light angle is set within a range of 5° or more and 85° or less. A maximum value of the reflectance B1 within a predetermined light reception angle range which does not include regular reflection of incident light (for example, since setting the incident light angle of the goniophotometer to 60° leads to a regular reflection angle of 60°, the predetermined light reception angle range is set to a range of 70° or more and 80° or less as a range which does not include regular reflection light) is measured. A maximum value of the reflectance A1 within a predetermined angle including regular reflection, a predetermined light reception angle range (for example, setting the incident light angle of the goniophotometer to 60° leads to a regular reflection angle of 60°, and the angle range P is set to a range of 55° or more and 65° or less) is measured. A ratio of the maximum value A1 to the maximum value B1 (A1/B1), when it is equal to or smaller than a predetermined value or equal to or greater than a predetermined value, can be used in evaluation of the matte-toned appearance in observation of the outer surface from various angles. Note that the reflectance is measured at, for example, predetermined light reception angle intervals (preferably within a range of 0.1° or more and 1.0° or less, and preferably at light reception angle intervals of) 0.1°.

In the case of an inspection step under the conditions described in the section “1. Laminated Structure and Physical Property of Exterior Material for Electrical Storage Devices” above, an inspection step of measuring, when a reflectance of the outer surface of the surface coating layer 6 is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is carried out. A specific method for measuring the ratio (A/B) is as described in the section “1. Laminated Structure and Physical Properties of Exterior Material for Electrical Storage Devices” above. In this case, whether or not the exterior material for electrical storage devices has an excellent matte-toned appearance even in observation of the outer surface thereof from various angles can be inspected on the basis of the ratio (A/B) measured. When the ratio (A/B) is 3.50 or less, it can be evaluated and determined that the exterior material for electrical storage devices has an excellent matte-toned appearance even in observation of the outer surface from various angles. The values of evaluation criteria can be varied depending on a design property level required for the exterior material for electrical storage devices, and conditions of the inspection step.

Preferred values of the respective physical properties based on a goniophotometer are as described in the section “1. Laminated Structure and Physical Properties of Exterior Material for Electrical Storage Devices” above, and can be applied to evaluation in the inspection step.

When the method for inspecting an appearance of an exterior material for electrical storage devices according to the present disclosure is used in a process of manufacturing an exterior material for electrical storage devices and a process of manufacturing an electrical storage device, an extraction step of extracting a test exterior material for electrical storage devices from exterior materials for electrical storage devices may be carried out, followed by application of the inspection step to the extracted exterior material for electrical storage devices. The test exterior material for electrical storage devices may be extracted randomly, or may be extracted at a predetermined rate (for example, exterior materials for electrical storage devices are extracted as test exterior materials for electrical storage devices at a rate of one out of every 1,000 to 10,000), or all exterior materials for electrical storage devices may be extracted as test exterior materials for electrical storage devices.

### EXAMPLES

Hereinafter, the present disclosure will be described in detail by way of examples and comparative examples. However, the present disclosure is not limited to examples.

### <Manufacturing of Exterior Material for Electrical Storage Devices>

### Example 1

A stretched nylon (ONy) film (thickness: 15 μm) was prepared as a base material layer. In addition, an aluminum foil (JIS H4160: 1994A 8021 H-O (thickness: 35 μm)) was prepared as a barrier layer. Next, an adhesive described later (a two-liquid urethane adhesive containing a colorant (carbon black)) was applied to one surface of the aluminum foil, so that an adhesive agent layer colored in black (thickness: 4 μm) was formed on the barrier layer. The adhesive agent layer on the barrier layer and the base material layer were then laminated by a dry lamination method, and aging treatment was then performed to prepare a laminate of base material layer/adhesive agent layer/barrier layer. Both surfaces of the aluminum foil are subjected to chemical conversion treatment. The chemical conversion treatment of the aluminum foil was performed by applying to both the surfaces of the aluminum foil a treatment liquid including a phenol resin, a chromium fluoride compound and phosphoric acid using a roll coating method in such a manner that the application amount of chromium was 10 mg/m² (dry mass), and performing baking.

Next, maleic anhydride-modified polypropylene as an adhesive layer (thickness: 15 μm) and random polypropylene as a heat-sealable resin layer (thickness: 20 μm) were co-extruded onto the barrier layer of the obtained laminate of the layers to laminate an adhesive layer and a heat-sealable resin layer on the barrier layer. Further, a resin composition 1 described later was applied to the surface of the obtained laminate to a thickness shown in Tables 1 and 2 and was cured under a formation condition 1 to form a matte-toned surface coating layer, so that an exterior material for electrical storage devices was obtained which included a laminate in which a surface coating layer (thickness: shown in Tables 1 and 2), a base material layer (thickness: 15 μm), an adhesive agent layer (4 μm), a barrier layer (35 μm), an adhesive layer (20 μm) and a heat-sealable resin layer (15 μm) were laminated in this order from the outside. In the obtained exterior material for electrical storage devices, the black color of the adhesive agent layer was visually recognized through the surface coating layer, and the appearance of the exterior material for electrical storage devices was black.

### Example 2 to 23 and Comparative Example 1 to 3

Except that a surface coating layer having a thickness shown in Tables 1 and 2 was formed by applying and curing each of resin compositions shown in Tables 1 and 2 under a formation condition shown in Tables 1 and 2, the same procedure as in Example 1 was carried out to obtain exterior materials for electrical storage devices which include the following layers in the following order from the outside. In each of the obtained exterior material for electrical storage devices, the black color of the adhesive agent layer was visually recognized through the surface coating layer, and the appearance of the exterior material for electrical storage devices was black.

Examples 2 and 18 to 21: Laminates in which a surface coating layer (thickness: shown in Tables 1 and 2), a base material layer (thickness: 15 μm), an adhesive agent layer (4 μm), a barrier layer (35 μm), an adhesive layer (20 μm) and a heat-sealable resin layer (15 μm) are laminated.

Examples 3 and 4: Laminates in which a surface coating layer (thickness: shown in Tables 1 and 2), a base material layer (thickness: 15 μm), an adhesive agent layer (4 μm), a barrier layer (35 μm), an adhesive layer (14 μm) and a heat-sealable resin layer (10 μm) are laminated.

Example 5: Laminates in which a surface coating layer (thickness: shown in Tables 1 and 2), a base material layer (thickness: 20 μm), an adhesive agent layer (4 μm), a barrier layer (30 μm), an adhesive layer (14 μm) and a heat-sealable resin layer (10 μm) are laminated.

Examples 6 and 7: Laminates in which a surface coating layer (thickness: shown in Tables 1 and 2), a base material layer (thickness: 25 μm), an adhesive agent layer (4 μm), a barrier layer (40 μm), an adhesive layer (22.5 μm) and a heat-sealable resin layer (22.5 μm) are laminated.

Examples 8 to 17 and Comparative Examples 1 to 3: Laminates in which a surface coating layer (thickness: shown in Tables 1 and 2), a base material layer (thickness: 20 μm), an adhesive agent layer (4 μm), a barrier layer (35 μm), an adhesive layer (14 μm) and a heat-sealable resin layer (10 μm) are laminated.

Examples 22 and 23: Laminates in which a surface coating layer (thickness: shown in Tables 1 and 2), a base material layer (thickness: 15 μm), an adhesive agent layer (4 μm), a barrier layer (30 μm), an adhesive layer (15 μm) and a heat-sealable resin layer (15 μm) are laminated.

### <Composition of Resin Composition for Forming Surface Coating Layer>

Resin composition 1: A resin composition in which a resin component of the surface coating layer contains an acryl-urethane-based resin (acrylic:urethane mass ratio=0:100), an inorganic filler (a barium-based filler having an average particle diameter: 1 μm), and an organic filler (average particle diameter: 2 μm) (the amount of the inorganic filler is larger than that of the organic filler).

Resin composition 2: A resin composition in which a resin component of the surface coating layer contains an acryl-urethane-based resin (acrylic:urethane mass ratio=90:10), an inorganic filler (silica particles having an average particle diameter of 1 μm), and an organic filler (average particle diameter: 2 μm) (the amount of the inorganic filler is smaller than that of the organic filler).

Resin composition 3: A resin composition in which a resin component of the surface coating layer contains an acryl-urethane-based resin (acrylic:urethane mass ratio=70:30), a polyol and an isocyanate at a charged ratio of 1 in terms of NCO/OH, an inorganic filler (silica particles having an average particle diameter of 1 μm), and an organic filler (average particle diameter: 2 μm) (the amount of the inorganic filler is smaller than that of the organic filler, and the blending ratio of the organic filler is approximately half that in the resin composition 2).

Resin composition 4: A resin composition in which a resin component of the surface coating layer contains an acryl-urethane-based resin (acrylic:urethane mass ratio=70:30), a polyol and an isocyanate at a charged ratio of 0.6 in terms of NCO/OH, an inorganic filler (silica particles having an average particle diameter of 1 μm), and an organic filler (average particle diameter: 2 μm) (the blending ratio of the organic filler and the inorganic filler is identical to that in the resin composition 3).

Resin composition 5: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is about 1.2 times that in the resin composition 3).

Resin composition 6: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is about 1.1 times that in the resin composition 3).

Resin composition 7: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is equivalent to that in the resin composition 3).

Resin composition 8: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is about 0.9 times that in the resin composition 3).

Resin composition 9: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is about 0.8 times that in the resin composition 3).

Resin composition 10: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is about 0.75 times that in the resin composition 3).

Resin composition 11: A resin composition in which a resin component of the surface coating layer contains an acryl-urethane-based resin (acrylic:urethane mass ratio=70:30), and an inorganic filler (silica particles having an average particle diameter of 1 μm) (the blending amount of the inorganic filler is about 0.65 times that in the resin composition 3).

Resin composition 12: A resin composition in which a resin component of the surface coating layer contains an acryl-urethane-based resin (acrylic:urethane mass ratio=50:50), and an inorganic filler (silica particles having an average particle diameter of 1 μm) (the blending amount of the inorganic filler is equivalent to that in the resin composition 3).

Resin composition 13: A resin composition in which a resin component of the surface coating layer contains an acryl-urethane-based resin (acrylic:urethane mass ratio=57:43), and an inorganic filler (silica particles having an average particle diameter of 1 μm) (the blending amount of the inorganic filler is equivalent to that in the resin composition 3).

Resin composition 14: A resin composition in which a resin component of the surface coating layer contains an acryl-urethane-based resin (acrylic:urethane mass ratio=64:36), and an inorganic filler (silica particles having an average particle diameter of 1 μm) (the blending amount of the inorganic filler is equivalent to that in the resin composition 3).

### <Method for Forming Surface Coating Layer>

Formation method 1: In the gravure printing method, the resin composition was applied to the surface of the base material layer using a plate A prepared by electronic engraving plate making, and aged.

Formation method 2: The resin composition was applied to the surface of the base material layer using a bar coater.

Formation method 3: In the gravure printing method, the resin composition was applied to the surface of the base material layer using a plate B made by laser engraving.

### <Measurement of Physical Properties of Surface Coating Layer by Goniophotometer>

The physical properties of the surface coating layer of the exterior materials for electrical storage devices in each of examples and comparative examples were measured by the following method using a goniophotometer. Tables 1 and 2 show the results.

Exterior materials for electrical storage devices were shaped into test pieces. A measuring device including a light source that generates light with which a test piece is irradiated, and a detector that detects light reflected by the test piece was prepared. As the measuring device, a goniophotometer GP-200 manufactured by MURAKAMI COLOR RESEARCH LABORATORY CO., LTD was used. The light source is a halogen lamp capable of outputting a power of 50 W at 12 V. The measuring device includes a dimming filter and a diaphragm located between the light source and the test piece or between the test piece and the detector.

First, a sample stage was angle-adjusted to an incidence angle of 60°. Next, an iris diaphragm was set to a diameter of 10.5 mm on the light source side, and an aperture diaphragm was set to a diameter of 9.1 mm on the detector side. Further, among sample pieces, samples having a low reflectance are fixed to the sample stage, and adjusted by a high voltage adjustment knob (HIGH VOLT ADJ) and a sensitivity adjustment dial (SENSITIVITY ADJ) so as to have a maximum reflectance of about 20 to 50% in a sensitivity check. For example, the high voltage adjustment knob (HIGH VOLT) is tuned to −520 V, and the sensitivity adjustment dial (SENSITIVITY) is tuned to 999 (maximum). Subsequently, standard plate black glass BK-7 (size 110×55 mm) was attached to the sample stage as a standard plate, and a dimming filter to be attached on the light source side was selected such that the maximum reflectance was about 50 to 90% in the sensitivity check. As the dimming filter, those of 1.0% and 50.0% were used in combination. As the standard black glass BK-7, a sample with a refractive index of 1.518 was used. A measurement step of allowing light from a light source to enter standard plate black glass, detecting light reflected by a surface of the standard plate black glass (hereinafter, also referred to as reflected light) with a detector, and measuring the light reflectance was carried out. By changing the angle of the detector, the intensity of the reflected light was measured at intervals of 0.1°. In the case of standard plate black glass, only regular reflected light at an angle of near 60° is detected, and therefore the intensity of reflected light emitted from the surface of the standard plate black glass at an angle of 45.0 to 75.0° was measured at intervals of 0.1°. The reflectance of the standard black glass was measured before and after the measurement of the sample piece, and the maximum value of the reflectance C and the maximum reflectance angle at this time were recorded.

Next, sample pieces were prepared. The sample piece was cut into a rectangular shape of 5 cm×6 cm, and fixed on a black plate of 6 cm×7 cm with a double-sided tape, followed by fixation of the periphery with a black tape. Further, the black plate on which the sample piece is fixed was fixed to a sample stage. A measurement step of allowing light from a light source to enter test piece, detecting light reflected by a surface of the test piece (hereinafter, also referred to as reflected light) with a detector, and measuring the light reflectance was carried out. A dimming filter to be attached on the light source side was selected such that the maximum reflectance was about 10 to 90% in the sensitivity check of the test piece. As the dimming filter, those of 1.0%, 10.0% and 50.0% were used alone or in combination. By changing the angle of the detector, the intensity of the reflected light emitted from the surface of the test piece at a light reception angle of −40.0° to 90.0° was measured at intervals of 0.1°. After completion of the measurement of the sample piece and the standard plate black glass, analysis was performed.

The analysis was performed as follows. First, the maximum reflectance angle of the standard black glass was set to 60.0°, and the angle of the sample piece was corrected. For example, when the maximum reflectance angle of the standard black glass was 61.0°, the sample piece measurement angle was shifted by 1.0°. Specifically, the sample piece measurement angle was corrected from 61.0° to 60.0°, and the sample piece measurement angle was corrected from 62.0° to 61.0°. Next, the maximum intensity between 55.0° and 65.0° after correction of the sample piece was read. This value was defined as a maximum value A. Further, the maximum intensity between 70.0° and 80.0° after correction of the sample piece was read. This value was defined as a maximum value B. A value obtained by dividing the maximum value A by the maximum value B was defined as a ratio of the maximum value A of the reflectance in a light reception angle range of 70.0° or more and 80.0° or less to the maximum value B of the reflectance in a light reception angle range of 55.0° or more and 65.0° or less.

Next, the reflectances A and B of the sample piece were converted to determine relative intensities a and b with respect to the maximum value Cf of the reflectance of the surface of the standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer. First, for the sample piece measured using the dimming filter, the maximum values Af and Bf of the reflectance after angle correction and after filter correction, respectively, were determined. In the filter correction of the sample measured using the dimming filter, values obtained by dividing reflectances A and B by 0.100 were maximum values Af and Bf after filter correction for A and B, respectively, when a 10.0% dimming filter was used, for example. Next, a filter correction value of the standard black glass BK-7 was determined. For example, when a 1.0% dimming filter and a 50.0% dimming filter were used, a value obtained by dividing the maximum value of the reflectance C of the standard black glass BK-7 by 0.010, and dividing the quotient by 0.50 was defined as a filter correction value Cf of the standard black glass BK-7. The relative intensity a of the maximum value of the reflectance A at a light reception angle of 55.0° to 65.0° when the maximum value of the reflectance Cf of the black glass BK-7 is defined as 100 was “(A/Cf)×100” for samples measured without using the diming filter, and “(Af/Cf)×100” for samples measured using the dimming filter. The relative intensity b of the maximum value B of the reflectance at a light reception angle of 70.0° to 80.0° when the maximum value of the reflectance Cf of the black glass BK-7 is defined as 100 was “(B/Cf)×100” for samples measured without using the diming filter, and “(Bf/Cf)×100” for samples measured using the dimming filter.

Next, a total E of reflectances of the sample piece (after angle correction) in a light reception angle range of −38.0° to 88.0° was determined. Specifically, the total E was determined by adding up all the intensities measured at a light reception angle of −38.0 to 88.0° and in steps of 0.1°. For the sample piece measured using the dimming filter, reflectances obtained at all the angles were filter-corrected, followed by determination of the total value Ef. Intensities obtained at all the angles may be filter-corrected, followed by determination of the total value Ef, or the total value E of reflectances at a light reception angle of −38.0° to 88.0° after angle correction may be determined, followed by correction of the dimming filter. Specifically, for example, when a 10.0% dimming filter was used, a value obtained by dividing the total value E in the light reception angle range of −38.0° to 88.0° by 0.100 was defined as the total Ef of reflectances at a light reception angle of −38.0° to 88.0° after angle correction and after filter correction. Further, a total of relative intensities with respect to the maximum value Cf of the reflectance of the standard plate black glass BK-7 is determined. The total of relative intensities at light reception angles of −38.0° to 88.0° when the maximum value Cf of the reflectance of the black glass BK-7 is defined as 100 was “(E/Cf)×100” for samples measured without using the diming filter, and “(Ef/Cf)×100” for samples measured using the dimming filter.

FIG. 5 shows a schematic diagram of a graph obtained using a goniophotometer represents the reflectance (%)).

### [Evaluation of Design Property]

The matte-toned design property of the outer surface (surface coating layer side) of the exterior material for electrical storage devices was evaluated by performing the following visual assessments 1 and 2. Tables 1 and 2 show the results.

### <Visual Assessment 1: (Evaluation of Difference in Color Shade Depending on Observation Angle)>

In an environment under a 1,000 lux light source, the surface of the surface coating layer was visually observed from a front direction (direction of) 90°, an oblique direction (direction of) 45° and a direction near the horizontal plane with respect to the surface of the surface coating layer, and the difference in black color shade depending on the angle of observation of the outer surface of the exterior material for electrical storage devices was evaluated on the basis of the following criteria.

I: A matte-toned black color is visually recognized in all of the front direction, the oblique direction and the direction near the horizontal plane. The exterior material for electrical storage devices can be evaluated as having a particularly excellent matte-toned appearance even in observation of the outer surface thereof from various angles.

II: A matte-toned black color equivalent to that in the criterion I is visually recognized in the front direction and the oblique direction, and the black color appears slightly lighter than that in the criterion I in the direction near the horizontal plane. The exterior material for electrical storage devices can be evaluated as having an excellent matte-toned appearance even in observation of the outer surface thereof from various angles.

III: A matte-toned black color equivalent to that in the criterion I is visually recognized in the front direction, the black color appears slightly lighter than that in the criterion I in the oblique direction, and the black color appears lighter than that in the criterion II in the direction near the horizontal plane. The exterior material for electrical storage devices can be evaluated as having an excellent matte-toned appearance even in observation of the outer surface thereof from various angles, although being inferior to that in criterion II.

IV: A matte-toned black color equivalent to that in the criterion I is visually recognized in the front direction, the black color appears lighter than that in the criterion II in the oblique direction, and the black color appears lighter than that in the criterion III in the direction near the horizontal plane. The exterior material for electrical storage devices cannot be evaluated as having an excellent matte-toned appearance in observation of the outer surface thereof from various angles.

### <Visual Assessment 2: (Evaluation of Shine)>

In an environment under a 1,000 lux light source, the surface of the surface coating layer was visually observed from a front direction (direction of) 90° and a direction near the horizontal plane with respect to the surface of the surface coating layer, and shine (shininess) of the outer surface of the exterior material for electrical storage devices was evaluated on the basis of the following criteria.

I: There is no shine in the front direction and the direction near the horizontal plane.

II: There is no shine in the front direction as in the criterion I, and there is almost no shine in the direction near the horizontal plane, but there is a slight shine as compared to the criterion I.

III: There is almost no shine in the front direction, but there is a slight shine as compared to the criterion I. and there is a heavier shine as compared to the criterion II in the direction near the horizontal plane.

IV: There is a heavy shine in the front direction and the direction near the horizontal plane.

TABLE 1

| | | | | | | | | | Compar- |
|---|---|---|---|---|---|---|---|---|---|
| | | | | | | | | | ative |
| | | Exam- | Exam- | Exam- | Exam- | Exam- | Exam- | Exam- | Exam- |
| Surface coating layer | | ple 1 | ple 2 | ple 3 | ple 4 | ple 5 | ple 6 | ple 7 | ple 1 |
| Resin composition | | 1 | 2 | 3 | 4 | 3 | 3 | 4 | 5 |
| Formation condition | | 1 | 1 | 1 | 1 | 1 | 1 | 1 | 2 |
| Thickness (μm) | | 2.0 | 2.0 | 2.0 | 2.0 | 2.0 | 2.0 | 2.0 | 0.6 |
| Physical | Maximum value A of reflectance/ | 2.49 | 1.91 | 2.46 | 3.23 | 2.88 | 2.05 | 3.27 | 25.89 |
| property | maximum value B of reflectance | | | | | | | | |
| measured | Maximum value A of reflectance at | 78.08 | 52.42 | 64.55 | 77.34 | 73.32 | 45.90 | 78.69 | 39.87 |
| with | light reception angle of | | | | | | | | |
| gonio- | 55.0° to 65.0° after angle correction | | | | | | | | |
| photometer | (measured value) | | | | | | | | |
| | Maximum value B of reflectance at | 31.42 | 27.51 | 26.29 | 23.97 | 25.44 | 22.34 | 24.05 | 1.54 |
| | light reception angle of | | | | | | | | |
| | 70.0° to 80.0° after angle correction | | | | | | | | |
| | (measured value) | | | | | | | | |
| | Maximum value of reflectance at | 78.1 | 52.4 | 64.6 | 77.3 | 73.3 | 45.9 | 78.7 | 399 |
| | light reception angle of 55.0° | | | | | | | | |
| | to 65.0° after angle correction and | | | | | | | | |
| | after filter correction | | | | | | | | |
| | Maximum value of reflectance at | 31.4 | 27.5 | 26.3 | 24.0 | 25.4 | 22.3 | 24.1 | 15.4 |
| | light reception angle of 70.0° | | | | | | | | |
| | to 80.0° after angle correction and | | | | | | | | |
| | after filter correction | | | | | | | | |
| | Relative intensity a of maximum | 0.58 | 0.39 | 0.48 | 0.58 | 0.55 | 0.34 | 0.59 | 3.0 |
| | value A of reflectance at light | | | | | | | | |
| | reception angle of 55.0° to 65.0° | | | | | | | | |
| | when maximum value Cf of | | | | | | | | |
| | reflectance of black glass BK-7 is | | | | | | | | |
| | defined as 100 | | | | | | | | |
| | Relative intensity b of maximum | 0.23 | 0.20 | 0.20 | 0.18 | 0.19 | 0.17 | 0.18 | 0.11 |
| | value B of reflectance at light | | | | | | | | |
| | reception angle of 70.0° to 80.0° | | | | | | | | |
| | when maximum value Cf of | | | | | | | | |
| | reflectance of black glass BK-7 is | | | | | | | | |
| | defined as 100 | | | | | | | | |
| | Measured value of total value of | 15046 | 12500 | 12917 | 12935 | 13576 | 10818 | 12562 | 1594 |
| | reflectances at light reception | | | | | | | | |
| | angle of −38.0° to 88.0° after angle | | | | | | | | |
| | correction | | | | | | | | |
| | Total of reflectances at light | 15046 | 12500 | 12917 | 12935 | 13576 | 10818 | 12562 | 15935 |
| | reception angle of −38.0° to 88.0° | | | | | | | | |
| | after angle correction and after | | | | | | | | |
| | filter correction | | | | | | | | |
| | Total of relative intensities at light | 112 | 93 | 96 | 96 | 101 | 81 | 94 | 119 |
| | reception angle of −38.0° to | | | | | | | | |
| | 88.0° when maximum value Cf of | | | | | | | | |
| | reflectance of black glass BK-7 | | | | | | | | |
| | is defined as 100 | | | | | | | | |
| Evaluation | Visual assessment 1 | II | II | II | III | II | II | III | IV |
| of | (Evaluation of difference in color | | | | | | | | |
| design | shade depending on observation | | | | | | | | |
| property | angle) | | | | | | | | |
| | Visual Determination 2 | II | II | II | II | II | I | II | II |
| | (evaluation of shine) | | | | | | | | |

| | | | | | | | Compar- |
|---|---|---|---|---|---|---|---|
| | | | | | | | ative |
| | | Exam- | Exam- | Exam- | Exam- | Exam- | Exam- |
| Surface coating layer | | ple 8 | ple 9 | ple 10 | ple 11 | ple 12 | ple 2 |
| Resin composition | | 5 | 5 | 6 | 7 | 8 | 9 |
| Formation condition | | 2 | 2 | 2 | 2 | 2 | 2 |
| Thickness (μm) | | 2.0 | 6.4 | 1.5 | 2.2 | 2.9 | 0.8 |
| Physical | Maximum value A of reflectance/ | 0.85 | 0.94 | 0.91 | 0.91 | 1.40 | 9.87 |
| property | maximum value B of reflectance | | | | | | |
| measured | Maximum value A of reflectance at | 13.35 | 26.05 | 16.43 | 20.58 | 89.65 | 31.57 |
| with | light reception angle of | | | | | | |
| gonio- | 55.0° to 65.0° after angle correction | | | | | | |
| photometer | (measured value) | | | | | | |
| | Maximum value B of reflectance at | 15.72 | 27.81 | 18.04 | 22.71 | 64.04 | 3.20 |
| | light reception angle of | | | | | | |
| | 70.0° to 80.0° after angle correction | | | | | | |
| | (measured value) | | | | | | |
| | Maximum value of reflectance at | 13.4 | 26.1 | 16.4 | 20.6 | 89.7 | 316 |
| | light reception angle of 55.0° | | | | | | |
| | to 65.0° after angle correction and | | | | | | |
| | after filter correction | | | | | | |
| | Maximum value of reflectance at | 15.7 | 27.8 | 18.0 | 22.7 | 64.0 | 32.0 |
| | light reception angle of 70.0° | | | | | | |
| | to 80.0° after angle correction and | | | | | | |
| | after filter correction | | | | | | |
| | Relative intensity a of maximum | 0.10 | 0.19 | 0.12 | 0.15 | 0.67 | 2.3 |
| | value A of reflectance at light | | | | | | |
| | reception angle of 55.0° to 65.0° | | | | | | |
| | when maximum value Cf of | | | | | | |
| | reflectance of black glass BK-7 is | | | | | | |
| | defined as 100 | | | | | | |
| | Relative intensity b of maximum | 0.12 | 0.21 | 0.13 | 0.17 | 0.48 | 0.24 |
| | value B of reflectance at light | | | | | | |
| | reception angle of 70.0° to 80.0° | | | | | | |
| | when maximum value Cf of | | | | | | |
| | reflectance of black glass BK-7 is | | | | | | |
| | defined as 100 | | | | | | |
| | Measured value of total value of | 7030 | 11929 | 7652 | 9758 | 24280 | 1872 |
| | reflectances at light reception | | | | | | |
| | angle of −38.0° to 88.0° after angle | | | | | | |
| | correction | | | | | | |
| | Total of reflectances at light | 7030 | 11929 | 7652 | 9758 | 24280 | 18717 |
| | reception angle of −38.0° to 88.0° | | | | | | |
| | after angle correction and after | | | | | | |
| | filter correction | | | | | | |
| | Total of relative intensities at light | 52 | 89 | 57 | 71 | 181 | 139 |
| | reception angle of −38.0° to | | | | | | |
| | 88.0° when maximum value Cf of | | | | | | |
| | reflectance of black glass BK-7 | | | | | | |
| | is defined as 100 | | | | | | |
| Evaluation | Visual assessment 1 | I | I | I | I | I | IV |
| of | (Evaluation of difference in color | | | | | | |
| design | shade depending on observation | | | | | | |
| property | angle) | | | | | | |
| | Visual Determination 2 | I | I | I | I | III | III |
| | (evaluation of shine) | | | | | | |

TABLE 2

| | | | | | Compar- | | | |
|---|---|---|---|---|---|---|---|---|
| | | | | | ative | | | |
| | | Exam- | Exam- | Exam- | Exam- | Exam- | Exam- | Exam- |
| Surface coating layer | | ple 13 | ple 14 | ple 15 | ple 3 | ple 16 | ple 17 | ple 18 |
| Resin composition | | 9 | 9 | 10 | 11 | 11 | 11 | 12 |
| Formation condition | | 2 | 2 | 2 | 2 | 2 | 2 | 2 |
| Thickness (μm) | | 2.3 | 5.5 | 2.7 | 0.5 | 2.9 | 5.9 | 2.0 |
| Physical | Maximum value A of reflectance/ | 1.62 | 0.99 | 3.24 | 35.47 | 3.23 | 2.28 | 0.91 |
| property | maximum value B of reflectance | | | | | | | |
| measured | Maximum value A of reflectance at | 64.65 | 49.15 | 22.44 | 81.23 | 29.47 | 28.13 | 44.14 |
| with | light reception angle of 55.0° | | | | | | | |
| gonio- | to 65.0° after angle correction | | | | | | | |
| photometer | (measured value) | | | | | | | |
| | Maximum value B of reflectance at | 39.97 | 49.85 | 8.45 | 2.29 | 9.11 | 12.35 | 48.54 |
| | light reception angle of 70.0° | | | | | | | |
| | to 80.0° after angle correction | | | | | | | |
| | (measured value) | | | | | | | |
| | Maximum value of reflectance at | 64.7 | 49.2 | 242 | 1620 | 295 | 281 | 44.1 |
| | light reception angle of 55.0° | | | | | | | |
| | to 65.0° after angle correction and | | | | | | | |
| | after filter correction | | | | | | | |
| | Maximum value of reflectance at | 40.0 | 49.9 | 74.5 | 45.8 | 91.1 | 124 | 48.5 |
| | light reception angle of 70.0° | | | | | | | |
| | to 80.0° after angle correction and | | | | | | | |
| | after filter correction | | | | | | | |
| | Relative intensity a of maximum | 0.48 | 0.37 | 1.8 | 12 | 2.2 | 2.1 | 0.33 |
| | value A of reflectance at light | | | | | | | |
| | reception angle of 55.0° to 65.0° | | | | | | | |
| | when maximum value Cf of | | | | | | | |
| | reflectance of black glass BK-7 is | | | | | | | |
| | defined as 100 | | | | | | | |
| | Relative intensity b of maximum | 0.30 | 0.37 | 0.55 | 0.34 | 0.68 | 0.92 | 0.36 |
| | value B of reflectance at light | | | | | | | |
| | reception angle of 70.0° to 80.0° | | | | | | | |
| | when maximum value Cf of | | | | | | | |
| | reflectance of black glass BK-7 is | | | | | | | |
| | defined as 100 | | | | | | | |
| | Measured value of total value of | 15607 | 19064 | 3015 | 3352 | 3723 | 4814 | 18432 |
| | reflectances at light reception | | | | | | | |
| | angle of −38.0° to 88.0° after angle | | | | | | | |
| | correction | | | | | | | |
| | Total of reflectances at light | 15607 | 19064 | 30150 | 67046 | 37226 | 48143 | 18432 |
| | reception angle of −38.0° to 88.0° | | | | | | | |
| | after angle correction and after | | | | | | | |
| | filter correction | | | | | | | |
| | Total of relative intensities at light | 116 | 142 | 225 | 490 | 277 | 359 | 137 |
| | reception angle of −38.0° to | | | | | | | |
| | 88.0° when maximum value Cf of | | | | | | | |
| | reflectance of black glass BK-7 | | | | | | | |
| | is defined as 100 | | | | | | | |
| Evaluation | Visual assessment 1 | I | I | III | IV | III | II | I |
| of | (Evaluation of difference in color | | | | | | | |
| design | shade depending on observation | | | | | | | |
| property | angle) | | | | | | | |
| | Visual Determination 2 | II | III | III | IV | IV | IV | III |
| | (evaluation of shine) | | | | | | | |

| | | Exam- | Exam- | Exam- | Exam- | Exam- |
|---|---|---|---|---|---|---|
| Surface coating layer | | ple 19 | ple 20 | ple 21 | ple 22 | ple 23 |
| Resin composition | | 13 | 14 | 1 | 7 | 14 |
| Formation condition | | 2 | 2 | 3 | 1 | 3 |
| Thickness (μm) | | 2.0 | 2.0 | 2.0 | 2.0 | 2.0 |
| Physical | Maximum value A of reflectance/ | 0.93 | 0.84 | 1.74 | 1.46 | 0.93 |
| property | maximum value B of reflectance | | | | | |
| measured | Maximum value A of reflectance at | 66.60 | 21.44 | 42.63 | 33.13 | 18.26 |
| with | light reception angle of 55.0° | | | | | |
| gonio- | to 65.0° after angle correction | | | | | |
| photometer | (measured value) | | | | | |
| | Maximum value B of reflectance at | 71.56 | 25.44 | 24.51 | 22.63 | 19.58 |
| | light reception angle of 70.0° | | | | | |
| | to 80.0° after angle correction | | | | | |
| | (measured value) | | | | | |
| | Maximum value of reflectance at | 66.6 | 21.4 | 42.6 | 33.1 | 18.3 |
| | light reception angle of 55.0° | | | | | |
| | to 65.0° after angle correction and | | | | | |
| | after filter correction | | | | | |
| | Maximum value of reflectance at | 71.6 | 25.4 | 24.5 | 22.6 | 19.6 |
| | light reception angle of 70.0° | | | | | |
| | to 80.0° after angle correction and | | | | | |
| | after filter correction | | | | | |
| | Relative intensity a of maximum | 0.50 | 0.16 | 0.32 | 0.24 | 0.13 |
| | value A of reflectance at light | | | | | |
| | reception angle of 55.0° to 65.0° | | | | | |
| | when maximum value Cf of | | | | | |
| | reflectance of black glass BK-7 is | | | | | |
| | defined as 100 | | | | | |
| | Relative intensity b of maximum | 0.53 | 0.19 | 0.18 | 0.17 | 0.14 |
| | value B of reflectance at light | | | | | |
| | reception angle of 70.0° to 80.0° | | | | | |
| | when maximum value Cf of | | | | | |
| | reflectance of black glass BK-7 is | | | | | |
| | defined as 100 | | | | | |
| | Measured value of total value of | 25161 | 10217 | 11306 | 10096 | 8839 |
| | reflectances at light reception | | | | | |
| | angle of −38.0° to 88.0° after angle | | | | | |
| | correction | | | | | |
| | Total of reflectances at light | 25161 | 10217 | 11306 | 10096 | 8839 |
| | reception angle of −38.0° to 88.0° | | | | | |
| | after angle correction and after | | | | | |
| | filter correction | | | | | |
| | Total of relative intensities at light | 188 | 76 | 84 | 74 | 65 |
| | reception angle of −38.0° to | | | | | |
| | 88.0° when maximum value Cf of | | | | | |
| | reflectance of black glass BK-7 | | | | | |
| | is defined as 100 | | | | | |
| Evaluation | Visual assessment 1 | I | I | II | I | I |
| of | (Evaluation of difference in color | | | | | |
| design | shade depending on observation | | | | | |
| property | angle) | | | | | |
| | Visual Determination 2 | III | I | I | I | I |
| | (evaluation of shine) | | | | | |

In all the exterior materials for electrical storage devices in Examples 1 to 23, the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less. From the evaluation by visual assessment 1 in Tables 1 and 2, the exterior materials for electrical storage devices in Examples 1 to 23 had an excellent matte-toned appearance even in observation of the outer surface of the outer surface of the exterior material for electrical storage devices from various angles.

In Examples 1 to 15 and 18 to 23, the relative intensity a of the maximum value A of the reflectance, when the maximum value Cf of the reflectance of the surface of the standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 2.0 or less. From the evaluation of visual assessment 2 in Tables 1 and 2, Examples 1 to 15 and 18 to 23 not only were excellent from the viewpoint of visual assessment 1, but also had a suppressed shine of the surface and were further excellent in matte-toned appearance in observation from various angles.

The exterior materials for electrical storage devices in Examples 8 to 11, 20 and 23 met the criterion I in both visual assessments 1 and 2, and had a particularly excellent matte-toned appearance. In Examples 6, 8, 11, and 20 to 23, the total of relative intensities was 89 or less, and from the viewpoint of shine suppression in visual assessment 2, the shine of the surface was suppressed and a particularly excellent matte-toned appearance was exhibited in observation from various angles. Examples 1 to 11,13 and 20 to 23 in which the relative intensity b of the maximum value B of the reflectance was 0.30 or less met the criterion I or the criterion II in visual assessment 2, and had a very high shine suppressing effect in observation from various angles.

As described above, the present disclosure provides the invention of aspects as shown below.

Item 1. An exterior material for electrical storage devices which includes a laminate including at least a surface coating layer, a base material layer, a barrier layer, and a heat-sealable resin layer in this order from an outside, in which
the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less.

Item 2. The exterior material for electrical storage devices according to item 1, in which the ratio of the maximum value A of the reflectance to the maximum value B of the reflectance (A/B) is 3.00 or less.

Item 3. The exterior material for electrical storage devices according to item 1 or 2, in which the ratio of the maximum value A of the reflectance to the maximum value B of the reflectance (A/B) is 1.70 or less.

Item 4. The exterior material for electrical storage devices according to any one of items 1 to 3, in which a relative intensity a of the maximum value A of the reflectance, when a maximum value Cf of a reflectance of a surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 2.0 or less.

Item 5. The exterior material for electrical storage devices according to any one of items 1 to 4, in which the relative intensity a of the maximum value A of the reflectance, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 0.50 or less.

Item 6. The exterior material for electrical storage devices according to any one of items 1 to 5, in which a relative intensity b of the maximum value B of the reflectance, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 1.0 or less.

Item 7. The exterior material for electrical storage devices according to any one of items 1 to 6, in which the relative intensity b of the maximum value B of the reflectance, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 0.30 or less.

Item 8. The exterior material for electrical storage devices according to any one of items 1 to 7, in which a total of relative intensities at angles in a light reception angle range of −38.0° or more and 88.0° or less, which are measured at light reception angle intervals of 0.1° under a condition of an incident light angle of 60° by using a goniophotometer for the outer surface of the surface coating layer, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 230 or less.

Item 9. The exterior material for electrical storage devices according to any one of items 1 to 8, in which the total of relative intensities at angles in a light reception angle range of −38.0° or more and 88.0° or less, which are measured at light reception angle intervals of 0.1° under a condition of an incident light angle of 60° by using a goniophotometer for the outer surface of the surface coating layer, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 120 or less.

Item 10. The exterior material for electrical storage devices according to any one of items 1 to 9, in which the total of relative intensities at angles in a light reception angle range of −38.0° or more and 88.0° or less, which are measured at light reception angle intervals of 0.1° under a condition of an incident light angle of 60° by using a goniophotometer for the outer surface of the surface coating layer, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 89 or less.

Item 11. The exterior material for electrical storage devices according to any one of items 1 to 10, including an adhesive agent layer between the base material layer and the barrier layer.

Item 12. The exterior material for electrical storage devices according to any one of items 1 to 11, including an adhesive layer between the barrier layer and the heat-sealable resin layer.

Item 13. The exterior material for electrical storage devices according to any one of items 1 to 12, in which the barrier layer is formed of an aluminum alloy foil or a stainless steel foil.

Item 14. A method for manufacturing an exterior material for electrical storage devices, including a step of preparing a laminate in which at least a surface coating layer, a base material layer, a barrier layer, and a heat-sealable resin layer are laminated in this order from the outside, in which the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less.

1-16. (canceled)

17. An exterior material for electrical storage devices, comprising a laminate including at least a surface coating layer, a base material layer, a barrier layer, and a heat-sealable resin layer in this order from an outside, wherein
the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less.

18. The exterior material for electrical storage devices according to claim 17, wherein the ratio of the maximum value A of the reflectance to the maximum value B of the reflectance (A/B) is 3.00 or less.

19. The exterior material for electrical storage devices according to claim 17, wherein the ratio of the maximum value A of the reflectance to the maximum value B of the reflectance (A/B) is 1.70 or less.

20. The exterior material for electrical storage devices according to claim 17, wherein a relative intensity a of the maximum value A of the reflectance, when a maximum value Cf of a reflectance of a surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 2.0 or less.

21. The exterior material for electrical storage devices according to claim 17, wherein the relative intensity a of the maximum value A of the reflectance, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 0.50 or less.

22. The exterior material for electrical storage devices according to claim 17, wherein a relative intensity b of the maximum value B of the reflectance, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 1.0 or less.

23. The exterior material for electrical storage devices according to claim 17, wherein the relative intensity b of the maximum value B of the reflectance, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 0.30 or less.

24. The exterior material for electrical storage devices according to claim 17, wherein a total of relative intensities at angles in a light reception angle range of −38.0° or more and 88.0° or less, which are measured at light reception angle intervals of 0.1° under a condition of an incident light angle of 60° by using a goniophotometer for the outer surface of the surface coating layer, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 230 or less.

25. The exterior material for electrical storage devices according to claim 17, wherein a total of relative intensities at angles in a light reception angle range of −38.0° or more and 88.0° or less, which are measured at light reception angle intervals of 0.1° under a condition of an incident light angle of 60° by using a goniophotometer for the outer surface of the surface coating layer, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 120 or less.

26. The exterior material for electrical storage devices according to claim 17, wherein the total of relative intensities at angles in a light reception angle range of −38.0° or more and 88.0° or less, which are measured at light reception angle intervals of 0.1° under a condition of an incident light angle of 60° by using a goniophotometer for the outer surface of the surface coating layer, when the maximum value Cf of the reflectance of the surface of standard plate black glass BK-7 with a refractive index of 1.518 in a light reception angle range of 55.0° or more and 65.0° or less, which is measured at light reception angle intervals of 0.1° under a condition of an incident light angle of 60° by using a goniophotometer is defined as 100, is 89 or less.

27. The exterior material for electrical storage devices according to claim 17, comprising an adhesive agent layer between the base material layer and the barrier layer.

28. The exterior material for electrical storage devices according to claim 17, comprising an adhesive layer between the barrier layer and the heat-sealable resin layer.

29. The exterior material for electrical storage devices according to claim 17, wherein the barrier layer is formed of an aluminum alloy foil or a stainless steel foil.

30. The exterior material for electrical storage devices according to claim 17, wherein the filler contains at least one selected from the group consisting of an organic filler and an inorganic filler.

31. The exterior material for electrical storage devices according to claim 30, wherein the inorganic filler contains silica.

32. The exterior material for electrical storage devices according to claim 30, wherein the inorganic filler contains kaolin.

33. The exterior material for electrical storage devices according to claim 30, wherein the inorganic filler contains titanium oxide.

34. The exterior material for electrical storage devices according to claim 30, wherein the inorganic filler contains barium sulfate.

35. The exterior material for electrical storage devices according to claim 30, wherein the organic filler contains at least one selected from the group consisting of nylon, polyacrylate, polyethylene, benzoguanamine and polystyrene.

36. A method for manufacturing an exterior material for electrical storage devices, comprising a step of preparing a laminate in which at least a surface coating layer, a base material layer, a barrier layer, and a heat-sealable resin layer are laminated in this order from an outside, wherein
the surface coating layer contains a resin and a filler, and when a reflectance of the outer surface of the surface coating layer is measured at light reception angle intervals of 0.1° under a condition of an incident light angle of 60° by using a goniophotometer, a ratio of a maximum value A of the reflectance in a light reception angle range of 55.0° or more and 65.0° or less to a maximum value B of the reflectance in a light reception angle range of 70.0° or more and 80.0° or less (A/B) is 3.50 or less.

37. An electrical storage device in which an electrical storage device element including at least a positive electrode, a negative electrode, and an electrolyte is housed in a packaging formed of the exterior material for electrical storage devices according to claim 17.

38. A method for inspecting an appearance of an exterior material for electrical storage devices, the method comprising:
a step of preparing an exterior material for electrical storage devices which includes a laminate including at least a surface coating layer, a base material layer, a barrier layer, and a heat-sealable resin layer in this order from an outside, the surface coating layer containing a resin and a filler; and
an inspection step of measuring a reflectance of the outer surface of the surface coating layer by using a goniophotometer.
